(19) United States
(12) Patent Application Publication
(10) Pub. No.: US 2026/0246151 A1
(43) Pub. Date: Aug. 20, 2026

(54) WIRELESS COMMUNICATION SYSTEM

(71) Applicant: DENSO CORPORATION, Kariya-city (JP)

(72) Inventors: Daiju USHIKOSHI, Nisshin-city (JP); Yuji SUGIMOTO, Nisshin-city (JP); Yuto HONDA, Kariya-city (JP); Tatsuhiro NUMATA, Kariya-city (JP)

(73) Assignee: DENSO CORPORATION, Kariya-city (JP)

(21) Appl. No.: 19/643,011

(22) Filed: Apr. 9, 2026

Related U.S. Application Data
(63) Continuation of application No. PCT/JP2024/027120, filed on Jul. 30, 2024.

(30) Foreign Application Priority Data
Oct. 12, 2023 (JP) 2023-176849

(51) Int. Cl. H01Q 13/02; H01Q 1/42

(52) U.S. Cl. CPC H01Q 13/0258; H01Q 1/42

(57) ABSTRACT

A wireless communication system includes a housing formed of a conductive material, battery packs installed in the housing, each battery pack having outer surfaces formed of a conductive material, and wireless communication devices, each of which includes an antenna. The antenna of each wireless communication device is disposed in a corresponding propagation path defined between the housing and one or more of the battery packs. The wireless communication devices perform radio-wave wireless communication with one another using a predetermined communication frequency. The antenna of each wireless communication device transmits and receives radio waves having a predetermined-directional polarization plane more strongly than other radio waves having polarization planes other than the predetermined-directional polarization plane. In the predetermined-directional polarization plane, a cutoff frequency defined based on a longitudinal length of a cross section of the corresponding propagation path is lower than the predetermined communication frequency.

### CROSS REFERENCE TO RELATED APPLICATION

This application is a bypass continuation application of currently pending international application No. PCT/JP2024/027120 filed on Jul. 30, 2024 designating the United States of America, the entire disclosure of which is incorporated herein by reference, the international application being based on and claiming the benefit of priority from Japanese Patent Application Publication No. 2023-176849 filed on Oct. 12, 2023, the disclosure of which is incorporated in its entirety herein by reference.

### TECHNICAL FIELD

The present disclosure relates to a wireless communication system including a plurality of wireless communication devices that perform wireless communication within a housing accommodating a plurality of battery packs.

### BACKGROUND

For example, a typical wireless communication system includes a battery management unit and a plurality of battery modules (see Japanese Patent Publication No. 7106766). The battery management unit includes first to third wireless transceiver modules each having an antenna for transmitting and receiving radio waves that have a polarization plane in the Z direction. The battery management unit also includes a fourth wireless transceiver module having an antenna for transmitting and receiving radio waves that have a polarization plane in the X direction.

Each of the battery modules includes a wireless transceiver module configured to communicate, through radio waves, with the battery management unit using a polarization diversity scheme.

The battery management unit of the patent publication is configured such that the number of wireless transceiver modules for transmitting and receiving radio waves having the Z-direction polarization plane is larger than that of wireless transceiver module for transmitting and receiving radio waves having the X-direction polarization plane; the Z direction of the polarization plane corresponds to the polarization direction in which the received power at the antenna is highest. The polarization direction in which the received power at the antenna is highest may be set in advance based on simulations or experimentations that take radio-wave multipath reflections into account.

This configuration therefore improves, even if such radio-wave diffuse reflections generated inside a metallic housing, such as a cabinet or a container, of the wireless transceiver system cause significant interference thereamong, the communication reliability of the wireless communication system.

### SUMMARY

The patent publication, however, merely discloses measures against significant interference caused by radio-wave diffuse reflections when the wireless communication system is used in a metallic housing, such as a cabinet or a container.

More recently, it has been considered to apply a wireless communication system to a battery system comprised of a conductive-material housing that is required to has a small size installable in hybrid vehicles or electric vehicles. Unfortunately, if the wireless communication system disclosed in the patent publication is applied to such a battery system comprised of a conductive-material housing that is required to have a compact size, simple consideration of the radio-wave diffuse reflections inside the conductive-material housing may be insufficient for improving the communication reliability of the wireless communication system.

From this viewpoint, the present disclosure seeks to provide wireless communication systems, each of which is capable of improving the communication reliability thereof even if the corresponding wireless communication system is applied to a battery system comprised of a conductive-material housing that is required to have a compact size installable in hybrid vehicles or electric vehicles.

Intensive study of wireless communication propagation paths based on a wireless communication system within a battery system comprised of a conductive-material housing required to have a compact size has found that simple consideration of radio-wave diffuse reflections inside the conductive-material housing may not achieve sufficient communication reliability of the wireless communication system.

In particular, it has been newly found that (i) a conductive housing, which is required to have a compact size, has an extremely narrow propagation path formed therein, and (ii) it is necessary to select a specified polarization plane of radio waves in the propagation path, which allows the radio waves to propagate through the propagation path.

From this viewpoint, the first aspect of the present disclosure provides a wireless communication system. The wireless communication system includes a housing formed of a conductive material, and a plurality of battery packs installed in the housing. Each of the battery packs has outer surfaces formed of a conductive material. The wireless communication system includes a plurality of wireless communication devices, each of which mainly includes an antenna. The antenna of each of the wireless communication devices is disposed in a corresponding one of propagation paths defined between the housing and one or more of the battery packs. The wireless communication devices are configured to perform radio-wave wireless communication with one another using a predetermined communication frequency.

The antenna of each of the wireless communication devices is configured to transmit and receive radio waves having a predetermined-directional polarization plane more strongly than other radio waves having polarization planes other than predetermined-directional polarization plane.

The predetermined-directional polarization plane of the antenna of each of the wireless communication devices is configured such that a cutoff frequency defined based on a longitudinal length of a cross section of the corresponding one of the propagation paths is lower than the predetermined communication frequency.

In the first aspect of the present disclosure, the housing is formed of a conductive material, such as metal, and the plurality of battery packs are installed in the housing. Each of the battery packs has the outer surfaces formed of a conductive material. Each of the plurality of wireless communication devices mainly includes an antenna, and the antenna of each of the wireless communication devices is disposed in a corresponding one of the propagation paths defined between the housing and one or more of the battery packs; an inner surface portion of each of the propagation paths is formed of the conductive material. The wireless communication devices are configured to perform radio-wave wireless communication with one another using the predetermined communication frequency. Thus, between radio-wave wireless communication between the wireless communication devices, each propagation path can be considered as a waveguide for radio waves.

In propagation of radio waves in a waveguide, propagation loss of radio waves having frequencies lower than a cutoff frequency of the waveguide becomes large. For example, a cutoff wavelength is defined based on the width a and the height b of a cross section of the waveguide. A vertical-polarization cutoff frequency fv when the mode order m is equal to 1 is defined by fv=c/2a, and a horizontal-polarization cutoff frequency fh when the mode order m is equal to 1 is defined by fh=c/2b.

From this viewpoint, the present disclosure focuses on the fact that the cutoff frequencies in each propagation path in which the antenna of a corresponding one of the wireless communication devices is arranged are respectively determined in accordance with the dimensions of the cross section of the corresponding propagation path. Additionally, the present disclosure focuses on the fact that wireless communication using radio waves having a predetermined communication frequency and a polarization plane whose cutoff frequency is lower than the predetermined communication frequency makes it possible to reduce propagation loss of the radio waves.

When the width a of the cross section of each propagation path is greater than the height b (a>b), the cutoff frequency fv for radio waves with vertical polarization is lower than the cutoff frequency fh for radio waves with horizontal polarization (fv<fh). In this case, because radio waves with horizontal polarization propagate when their frequency is higher than the cutoff frequency fh, whereas radio waves with vertical polarization propagate when their frequency is higher than the cutoff frequency fv, which is lower than fh, the radio waves with vertical polarization is more likely propagate than the radio waves with horizontal polarization.

That is, the cutoff frequency for radio waves with vertical polarization, which corresponds to the predetermined-directional polarization plane, is defined based on the width a of the cross section of the propagation path (i.e., the length of the cross section in the longitudinal direction), and is lower than the cutoff frequency for radio waves with other polarization planes other than the predetermined-directional polarization plane.

Accordingly, each of the wireless communication devices mainly includes the antenna that transmits and receives radio waves having the predetermined-directional polarization plane more strongly than radio waves having polarization planes other than the predetermined-directional polarization plane.

This configuration therefore makes it possible to reduce, as much as possible, the number of antennas included in the wireless communication devices as compared with a comparative example where the wireless communication devices each includes antennas for transmitting and receiving radio waves having polarization planes in multiple directions.

Additionally, each propagation path is configured such that the cutoff frequency for radio waves having the predetermined-directional polarization plane is lower than the predetermined communication frequency.

Therefore, wireless communication using radio waves having the predetermined-directional polarization plane makes it possible to reduce the cutoff frequency to be lower than the predetermined communication frequency for each of the wireless communication devices, thus suppressing propagation loss. This improves the communication reliability in the wireless communication system.

In the second aspect of the aspect of the present disclosure, the plurality of wireless communication devices includes a first wireless communication device and a second wireless communication device that are configured to perform radio-wave wireless communication with one another using the predetermined communication frequency. The propagation paths include a first propagation path in which the antenna of the first wireless communication device is disposed, a first polarization plane and a second polarization plane orthogonal to each other being defined in the first propagation path. A first radio-wave cutoff frequency of the first polarization plane is defined in the first propagation path. A third radio-wave cutoff frequency of the second polarization plane is defined in the first propagation path. The propagation paths include a second propagation path in which the antenna of the second wireless communication device is disposed. A second radio-wave cutoff frequency of the first polarization plane is defined in the second propagation path. A fourth radio-wave cutoff frequency of the second polarization plane is defined in the second propagation path. The predetermined communication frequency is set to be higher than the first and third radio-wave cutoff frequencies, higher than the second radio-wave cutoff frequency, and lower the fourth radio-wave cutoff frequency. The predetermined-directional plane is the first polarization plane.

The first and second wireless communication devices included in the plurality of wireless communication devices are configured to perform radio-wave wireless communication with one another using the predetermined communication frequency. The antenna of the first wireless communication antenna is disposed in the first propagation path. The first polarization plane and the second polarization plane orthogonal to each other are defined in the first propagation path. The first radio-wave cutoff frequency of the first polarization plane is defined in the first propagation path. The third radio-wave cutoff frequency of the second polarization plane is defined in the first propagation path. That is, in the first propagation path, the cutoff frequency of the first polarization plane is the first cutoff frequency, and the cutoff frequency of the second polarization plane is the third cutoff frequency.

The antenna of the second wireless communication device is disposed in the second propagation path. The second radio-wave cutoff frequency of the first polarization plane is defined in the second propagation path. The fourth radio-wave cutoff frequency of the second polarization plane is defined in the second propagation path. That is, in the second propagation path, the cutoff frequency of the first polarization plane is the second cutoff frequency, and the cutoff frequency of the second polarization plane is the fourth cutoff frequency.

The predetermined communication frequency is set to be higher than the first and third radio-wave cutoff frequencies. This therefore makes it possible to reduce propagation loss in wireless communication in the first propagation path even if the wireless communication uses radio waves having any one of the first polarization plane and the second polarization plane.

Additionally, the predetermined communication frequency is set to be higher than the second cutoff frequency and lower than the fourth cutoff frequency.

This therefore makes it possible to reduce propagation loss in wireless communication in the second propagation path when radio waves having the first polarization plane, which corresponds to the predetermined-directional polarization plane, are used instead of the usage of radio waves having the second polarization plane. Accordingly, the above configuration makes it possible to, even if each of the wireless communication devices mainly includes the antenna for transmitting and receiving radio waves having the first polarization plane, maintain communication reliability through each of the first and second propagation paths.

Specifically, as described in the third aspect of the present disclosure, the housing has an inner upper surface, an inner lower surface, and a pair of inner side surfaces, and the first propagation path is defined by the inner upper surface, the inner lower surface, and the pair of inner side surfaces of the housing. A distance between the inner upper and lower surfaces of the housing is smaller than that between the pair of inner side surfaces of the housing. The outer surfaces of each battery pack include an outer upper surface, and the second propagation path is defined by the inner upper surface of the housing, the outer upper surfaces of the battery packs, and the pair of inner side surfaces of the housing. A distance between the inner upper surface of the housing and the outer upper surface of each battery pack is smaller than that between the pair of inner side surfaces of the housing. The first polarization plane is a vertical-polarization plane. The second polarization plane is a horizontal-polarization plane. The above configuration of the wireless communication system of the third aspect satisfies the concept of the second aspect when the predetermined-directional polarization plane is the vertical polarization plane, and therefore makes it possible to, even if each of the wireless communication devices mainly includes the antenna for transmitting and receiving radio waves having the first polarization plane, maintain communication reliability through each of the first and second propagation paths.

In the fourth aspect of the present disclosure, the plurality of wireless communication devices includes a first wireless communication device and a second wireless communication device that are configured to perform radio-wave wireless communication with one another using the predetermined communication frequency. The propagation paths include a first propagation path in which the antenna of the first wireless communication device is disposed, a first polarization plane and a second polarization plane orthogonal to each other being defined in the first propagation path. A first radio-wave cutoff frequency of the first polarization plane is defined in the first propagation path. A third radio-wave cutoff frequency of the second polarization plane is defined in the first propagation path. The propagation paths include a second propagation path in which the antenna of the second wireless communication device is disposed. A second radio-wave cutoff frequency of the first polarization plane is defined in the second propagation path. A fourth radio-wave cutoff frequency of the second polarization plane is defined in the second propagation path. The predetermined communication frequency is set to be higher than the first and third radio-wave cutoff frequencies, lower than the second radio-wave cutoff frequency, and higher than the fourth radio-wave cutoff frequency. The predetermined-directional plane is the second polarization plane.

The predetermined communication frequency is set to be higher than the first and third radio-wave cutoff frequencies. This therefore makes it possible to reduce propagation loss in wireless communication in the first propagation path even if the wireless communication uses radio waves having any one of the first polarization plane and the second polarization plane.

Additionally, the predetermined communication frequency is set to be lower than the second cutoff frequency and higher than the fourth cutoff frequency.

This therefore makes it possible to reduce propagation loss in wireless communication in the second propagation path when radio waves having the second polarization plane, which corresponds to the predetermined-directional polarization plane, are used instead of the usage of radio waves having the first polarization plane. Accordingly, the above configuration makes it possible to, even if each of the wireless communication devices mainly includes the antenna for transmitting and receiving radio waves having the second polarization plane, maintain communication reliability through each of the first and second propagation paths.

Specifically, as described in the fifth aspect of the present disclosure, the housing has an inner upper surface, an inner lower surface, and a pair of inner side surfaces. The first propagation path is defined by the inner upper surface, the inner lower surface, and the pair of inner side surfaces of the housing. A distance between the inner upper and lower surfaces of the housing is smaller than that between the pair of inner side surfaces of the housing. The outer surfaces of each battery pack include an outer side surface. The second propagation path is defined by the inner upper surface of the housing, the inner lower surface of the housing, the outer side surfaces of the battery packs, and one of the pair of inner side surfaces of the housing. A distance between the inner upper and lower surfaces of the housing is greater than that between the outer side surface of each battery pack and the one of the pair of inner side surfaces of the housing. The first polarization plane is a vertical-polarization plane, and the second polarization plane is a horizontal-polarization plane. The predetermined communication frequency is set to be higher than the first and third radio-wave cutoff frequencies. The above configuration of the wireless communication system of the fifth aspect satisfies the concept of the fourth aspect when the predetermined-directional polarization plane is the horizontal polarization plane, and therefore makes it possible to reduce propagation loss in wireless communication in the first propagation path even if the wireless communication uses radio waves having any one of the first polarization plane and the second polarization plane.

In the sixth aspect of the present disclosure, the plurality of wireless communication devices includes a first wireless communication device and a second wireless communication device that are configured to perform radio-wave wireless communication with one another using the predetermined communication frequency. The propagation paths include a first propagation path in which the antenna of the first wireless communication device is disposed, a first polarization plane and a second polarization plane orthogonal to each other being defined in the first propagation path. A first radio-wave cutoff frequency of the first polarization plane is defined in the first propagation path. A third radio-wave cutoff frequency of the second polarization plane is defined in the first propagation path. The propagation paths include a second propagation path in which the antenna of the second wireless communication device is disposed. A second radio-wave cutoff frequency of the first polarization plane is defined in the second propagation path. A fourth radio-wave cutoff frequency of the second polarization plane is defined in the second propagation path. A predetermined additional propagation path is present between the antenna of the first wireless communication device and the antenna of the second wireless communication device. The predetermined additional propagation path results in polarization rotation in radio waves transmitted from the antenna of each of the first and second wireless communication devices. The predetermined communication frequency is set to be higher than the first and third radio-wave cutoff frequencies, lower than the second radio-wave cutoff frequency, and higher than the fourth radio-wave cutoff frequency. The predetermined-directional plane is the second polarization plane at a position of the antenna of the second wireless communication device in the second propagation path.

In the configuration of the sixth aspect, the predetermined additional propagation path is present between the antenna of the first wireless communication device and the antenna of the second wireless communication device. The predetermined additional propagation path results in polarization rotation in radio waves transmitted from the antenna of each of the first and second wireless communication devices. In this case, radio waves transmitted from, for example, the antenna of the first wireless communication device may undergo polarization rotation in the predetermined additional propagation path, resulting in the radio waves, which have the second polarization plane, being changed into radio waves having the first polarization plane at the position of the antenna of the second wireless communication device.

In the sixth aspect, the predetermined communication frequency is set to be higher than the first and third radio-wave cutoff frequencies. This therefore makes it possible to reduce propagation loss in wireless communication in the first propagation path even if the wireless communication uses radio waves having any one of the first polarization plane and the second polarization plane.

Additionally, the predetermined communication frequency is set to be lower than the second cutoff frequency and higher than the fourth cutoff frequency.

This therefore makes it possible to reduce propagation loss in wireless communication in the second propagation path when radio waves having the second polarization plane, which corresponds to the predetermined-directional polarization plane, are used instead of the usage of radio waves having the first polarization plane. At that time, the predetermined-directional plane is the second polarization plane at the position of the antenna of the second wireless communication device in the second propagation path. Accordingly, the above configuration makes it possible to, even if each of the wireless communication devices mainly includes the antenna for transmitting and receiving radio waves having the predetermined-directional polarization plane, maintain communication reliability through each of the first and second propagation paths.

Specifically, as described in the seventh aspect of the present disclosure, the housing has an inner upper surface, an inner lower surface, and a pair of inner side surfaces. The first propagation path is defined by the inner upper surface, the inner lower surface, and the pair of inner side surfaces of the housing. A distance between the inner upper and lower surfaces of the housing is smaller than that between the pair of inner side surfaces of the housing. The outer surfaces of each battery pack include an outer upper surface. The predetermined additional propagation path includes a third propagation path that is defined by the inner upper surface of the housing, the outer upper surfaces of the battery packs, and the pair of inner side surfaces of the housing. A distance between the inner upper surface of the housing and the outer upper surface of each battery pack is smaller than that between the pair of inner side surfaces of the housing. The second propagation path is defined by the inner upper surface of the housing, the inner lower surface of the housing, the outer side surfaces of the battery packs, and one of the pair of inner side surfaces of the housing. A distance between the inner upper and lower surfaces of the housing is greater than that between the outer side surface of each battery pack and the one of the pair of inner side surfaces of the housing. The second polarization plane is a horizontal polarization plane at the position of the antenna of the second wireless communication device in the second propagation path.

The above configuration of the wireless communication system of the seventh aspect satisfies the concept of the sixth aspect when the predetermined-directional polarization plane is the horizontal polarization plane at the position of the antenna of the second wireless communication device in the second propagation path, and therefore makes it possible to reduce propagation loss in wireless communication in the second propagation path even if the wireless communication uses radio waves having any one of the first polarization plane and the second polarization plane.

In the eight aspect of the present disclosure, each of the wireless communication devices includes only the antenna configured to transmit and receive the radio waves having the predetermined-directional polarization plane more strongly than the other radio waves having the polarization planes other than the predetermined-directional polarization plane. This configuration makes it possible to maintain communication reliability while minimizing the number of antennas included in the wireless communication system.

The ninth aspect of the present disclosure provides a wireless communication system. The wireless communication system includes a housing formed of a conductive material and having an inner upper surface, an inner lower surface, and a pair of inner side surfaces. The wireless communication system includes a plurality of battery packs installed in the housing, each of the battery packs having outer surfaces formed of a conductive material, the outer surfaces including an outer upper surface. The wireless communication system includes a first wireless communication device and a second wireless communication device. Each of the first and second communication devices mainly includes an antenna disposed in a corresponding one of first and second propagation paths defined between the housing and one or more of the battery packs. The first and second wireless communication devices are configured to perform radio-wave wireless communication with one another using a predetermined communication frequency. A first radio-wave cutoff frequency of a vertical polarization plane is defined in the first propagation path. A third radio-wave cutoff frequency of a horizontal polarization plane is defined in the first propagation path. The first propagation path is defined by the inner upper surface, the inner lower surface, and the pair of inner side surfaces of the housing. A distance between the inner upper and lower surfaces of the housing is smaller than that between the pair of inner side surfaces of the housing. A second radio-wave cutoff frequency of the vertical polarization plane is defined in the second propagation path. A fourth radio-wave cutoff frequency of the horizontal polarization plane is defined in the second propagation path. The second propagation path is defined by the inner upper surface of the housing, the outer upper surfaces of the battery packs, and the pair of inner side surfaces of the housing. A distance between the inner upper surface of the housing and the outer upper surface of each battery pack is smaller than that between the pair of inner side surfaces of the housing. The predetermined communication frequency is set to be higher than the first and third radio-wave cutoff frequencies, higher than the second radio-wave cutoff frequency, and lower than the fourth radio-wave cutoff frequency. The antenna of each of the first and second wireless communication devices is configured to transmit and receive radio waves having the vertical polarization plane more strongly than other radio waves having polarization planes other than the vertical polarization plane.

In the configuration of the ninth aspect, each of the first and second wireless communication devices mainly includes the antenna, and the antenna of each of the first and second wireless communication devices is disposed in a corresponding one of the first and second propagation paths defined between the housing and one or more of the battery packs. The first and second wireless communication devices are configured to perform radio-wave wireless communication with one another using the predetermined communication frequency. Thus, between radio-wave wireless communication between the first and second wireless communication devices, each propagation path can be considered as a waveguide for radio waves.

The antenna of the first wireless communication antenna is disposed in the first propagation path. That is, in the first propagation path, the cutoff frequency of the vertical polarization plane is the first cutoff frequency, and the cutoff frequency of the horizontal polarization plane is the third cutoff frequency. Specifically, the first propagation path is defined by the inner upper surface, the inner lower surface, and the pair of inner side surfaces of the housing. The distance between the inner upper and lower surfaces of the housing is smaller than that between the pair of inner side surfaces of the housing. This configuration results in the first cutoff frequency being lower than the third cutoff frequency.

The antenna of the second wireless communication device is disposed in the second propagation path. That is, in the second propagation path, the cutoff frequency of the vertical polarization plane is the second cutoff frequency, and the cutoff frequency of the horizontal polarization plane is the fourth cutoff frequency. Specifically, the second propagation path is defined by the inner upper surface of the housing, the outer upper surfaces of the battery packs, and the pair of inner side surfaces of the housing. The distance between the inner upper surface of the housing and the outer upper surface of each battery pack is smaller than that between the pair of inner side surfaces of the housing. This configuration results in the second cutoff frequency being lower than the fourth cutoff frequency and the first cutoff frequency.

The predetermined communication frequency is set to be higher than the first and third radio-wave cutoff frequencies. This therefore makes it possible to reduce propagation loss in wireless communication in the first propagation path even if the wireless communication uses radio waves having any one of the vertical polarization plane and the horizontal polarization plane.

Additionally, the predetermined communication frequency is set to be higher than the second cutoff frequency and lower than the fourth cutoff frequency. This therefore makes it possible to reduce propagation loss in wireless communication in the second propagation path when radio waves having the vertical polarization plane are used instead of the usage of radio waves having the horizontal polarization plane. Accordingly, the above configuration makes it possible to, even if each of the first and second wireless communication devices mainly includes the antenna for transmitting and receiving radio waves having the vertical polarization plane, maintain communication reliability through each of the first and second propagation paths.

In the tenth aspect of the present disclosure, each of the first and second wireless communication devices includes only the antenna configured to transmit and receive the radio waves having the vertical polarization plane more strongly than the other radio waves having the polarization planes other than the vertical polarization plane. This configuration makes it possible to maintain communication reliability while minimizing the number of antennas included in the wireless communication system.

The eleventh aspect of the present disclosure provides a wireless communication system. The wireless communication system includes a housing formed of a conductive material and having an inner upper surface, an inner lower surface, and a pair of inner side surfaces. The wireless communication system includes a plurality of battery packs installed in the housing, each of the battery packs having outer surfaces formed of a conductive material, the outer surfaces including an outer side surface. The wireless communication system includes a first wireless communication device and a second wireless communication device. Each of the first and second communication devices mainly includes an antenna disposed in a corresponding one of first and second propagation paths defined between the housing and one or more of the battery packs. The first and second wireless communication devices are configured to perform radio-wave wireless communication with one another using a predetermined communication frequency. A first radio-wave cutoff frequency of a vertical polarization plane is defined in the first propagation path. A third radio-wave cutoff frequency of a horizontal polarization plane is defined in the first propagation path. The first propagation path is defined by the inner upper surface, the inner lower surface, and the pair of inner side surfaces of the housing. A distance between the inner upper and lower surfaces of the housing is smaller than that between the pair of inner side surfaces of the housing. A second radio-wave cutoff frequency of the vertical polarization plane is defined in the second propagation path, and a fourth radio-wave cutoff frequency of the horizontal polarization plane is defined in the second propagation path. The second propagation path is defined by the inner upper surface of the housing, the inner lower surface of the housing, the outer side surfaces of the battery packs, and one of the pair of inner side surfaces of the housing. A distance between the inner upper and lower surfaces of the housing is greater than that between the outer side surface of each battery pack and the one of the pair of inner side surfaces of the housing. The predetermined communication frequency is set to be higher than the first and third radio-wave cutoff frequencies, lower than the second radio-wave cutoff frequency, and higher than the fourth radio-wave cutoff frequency. The antenna of each of the first and second wireless communication devices is configured to transmit and receive radio waves having a horizontal polarization plane more strongly than other radio waves having polarization planes other than the horizontal polarization plane.

In the configuration of the ninth aspect, the antenna of the first wireless communication antenna is disposed in the first propagation path. That is, in the first propagation path, the cutoff frequency of the vertical polarization plane is the first cutoff frequency, and the cutoff frequency of the horizontal polarization plane is the third cutoff frequency. Specifically, the first propagation path is defined by the inner upper surface, the inner lower surface, and the pair of inner side surfaces of the housing. The distance between the inner upper and lower surfaces of the housing is smaller than that between the pair of inner side surfaces of the housing. This configuration results in the first cutoff frequency being lower than the third cutoff frequency.

The antenna of the second wireless communication device is disposed in the second propagation path. That is, in the second propagation path, the cutoff frequency of the vertical polarization plane is the second cutoff frequency, and the cutoff frequency of the horizontal polarization plane is the fourth cutoff frequency. Specifically, the second propagation path is defined by the inner upper surface of the housing, the inner lower surface of the housing, the outer side surfaces of the battery packs, and one of the pair of inner side surfaces of the housing. The distance between the inner upper and lower surfaces of the housing is greater than that between the outer side surface of each battery pack and the one of the pair of inner side surfaces of the housing. This configuration results in the fourth cutoff frequency being lower than the second cutoff frequency.

The predetermined communication frequency is set to be higher than the first and third radio-wave cutoff frequencies. This therefore makes it possible to reduce propagation loss in wireless communication in the first propagation path even if the wireless communication uses radio waves having any one of the vertical polarization plane and the horizontal polarization plane.

Additionally, the predetermined communication frequency is set to be lower than the second radio-wave cutoff frequency and higher than the fourth radio-wave cutoff frequency. This therefore makes it possible to reduce propagation loss in wireless communication in the second propagation path when radio waves having the horizontal polarization plane are used instead of the usage of radio waves having the vertical polarization plane. Accordingly, the above configuration makes it possible to, even if each of the first and second wireless communication devices mainly includes the antenna for transmitting and receiving radio waves having the horizontal polarization plane, maintain communication reliability through each of the first and second propagation paths.

In the twelfth aspect of the present disclosure, each of the first and second wireless communication devices includes only the antenna configured to transmit and receive the radio waves having the horizontal polarization plane more strongly than the other radio waves having the polarization planes other than the horizontal polarization plane. This configuration makes it possible to maintain communication reliability while minimizing the number of antennas included in the wireless communication system.

### BRIEF DESCRIPTION OF THE DRAWINGS

Other aspects of the present disclosure will become apparent from the following description of embodiments with reference to the accompanying drawings in which:

FIG. 1 is an overall structural view of a battery monitoring apparatus according to the first embodiment;

FIG. 2 is a sectional view taken along line II-II of FIG. 1;

FIG. 3 is a sectional view taken along line III-III of FIG. 1;

FIG. 4 is a perspective view illustrating a waveguide and the lowest-order modes of vertical polarization and horizontal polarization;

FIG. 5 is a plan view of a modified example of the battery system according to the first embodiment;

FIG. 6 is a plan view of an additional modified example of the battery system according to the first embodiment;

FIG. 7 is a plan view of a battery system according to a second embodiment;

FIG. 8 is a sectional view taken along line VIII-VIII of FIG. 7;

FIG. 9 is a sectional view taken along line IX-IX of FIG. 7;

FIG. 10 is a plan view of a first modified example of the battery system according to the second embodiment;

FIG. 11 is a plan view of a second modified example of the battery system according to the second embodiment;

FIG. 12 is a plan view of a third modified example of the battery system according to the second embodiment;

FIG. 13 is a plan view of a battery system according to the third embodiment;

FIG. 14 is a sectional view taken along line XIV-XIV of FIG. 13;

FIG. 15 is a sectional view taken along line XV-XV of FIG. 13;

FIG. 16 is a plan view illustrating a housing according to a first modification;

FIG. 17 is a plan view illustrating a housing according to a second modification;

FIG. 18 is a plan view of a housing according to a third modification;

FIG. 19 is a side view of a battery system according to a fourth modification;

FIG. 20 is a plan view of a battery system according to a fifth modification;

FIG. 21 is a plan view of a battery system according to a sixth modification;

Each of FIGS. 22A to 22E is a front view illustrating a corresponding one of various types of antennas;

Each of FIGS. 23A to 23C is a perspective view of a corresponding one of examples of a vertically polarized antenna;

Each of FIGS. 24A and 24B is a perspective view of a corresponding one of additional examples of the vertically polarized antenna;

FIG. 25 is a perspective view of an example of a horizontally polarized antenna;

FIG. 26 is a perspective view of another example of the horizontally polarized antenna;

FIG. 27 is a front view of a further example of the horizontally polarized antenna;

FIG. 28 is a rear view of a still further example of the horizontally polarized antenna;

FIG. 29 is a rear view of a fourth modified example of the horizontally polarized antenna;

FIG. 30 is a rear view of a fifth modified example of the horizontally polarized antenna;

FIG. 31 is a sectional view illustrating a modification of the battery system according to the third embodiment, which corresponds to the sectional view taken along line XIV-XIV of FIG. 13;

FIG. 32 is a side view of a modification of the horizontally polarized antenna and a bracket;

FIG. 33 is a schematic view illustrating a configuration of mesh communication; and

FIG. 34 is a plan view of a modified example of the housing.

### DETAILED DESCRIPTION OF EMBODIMENTS

The following describes exemplary embodiments of a wireless communication system applied to a battery system installable in hybrid vehicles or electric vehicles with reference to the drawings.

### First Embodiment

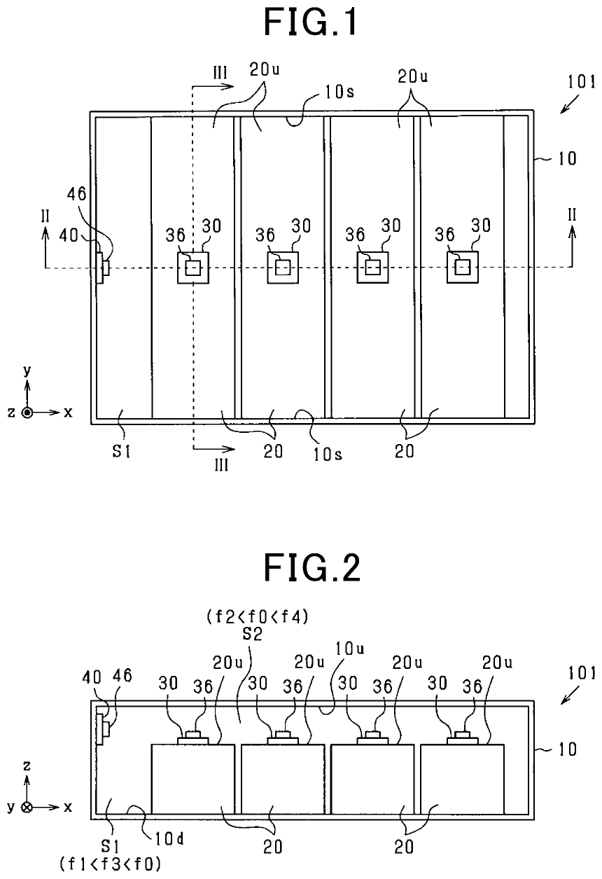

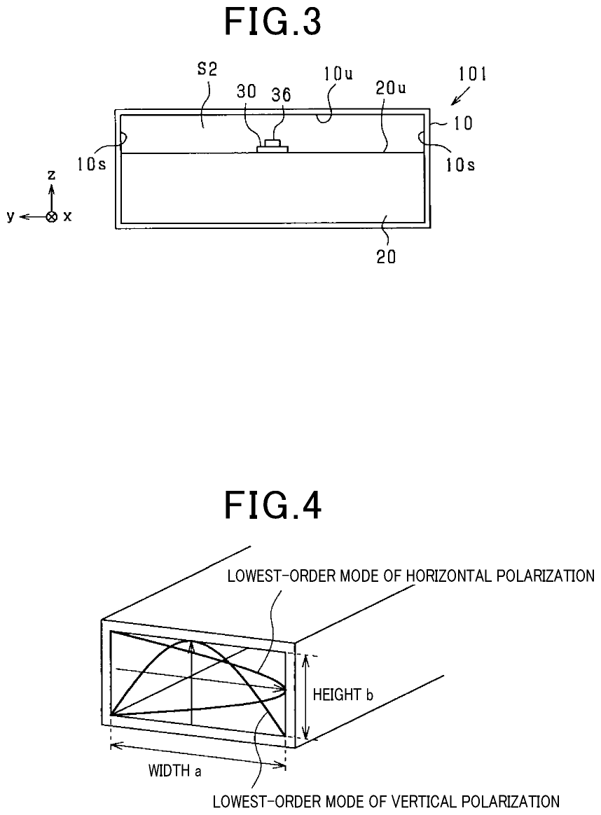

FIG. 1 is a plan view of a battery system 101 including a housing 10, FIG. 2 is a sectional view taken along line II-II of FIG. 1, and FIG. 3 is a sectional view taken along line III-III of FIG. 1. In FIG. 1, an upper wall portion of the housing 10 is omitted.

The battery system 101 is mounted in, for example, a hybrid vehicle. The battery system 101 includes the housing 10 formed of a conductive material serving as a conductor, such as metal. The battery system 101 also includes a plurality of battery packs 20 installed in the housing 10, a plurality of acquisition devices 30, and a monitoring device 40. The acquisition devices 30 and the monitoring device 40 constitute a battery monitoring system serving as a wireless communication system for monitoring the respective battery packs 20.

In accordance with the drawings, three mutually orthogonal directions are respectively defined as a left-right direction X, a front-rear direction Y, and an up-down direction Z. However, the battery system 101 may be installed in any orientation. For example, the up-down direction Z may be oriented as a left-right or front-rear direction.”

For the sake of convenience in the following description, three mutually orthogonal directions are defined as a left-right direction X, a front-rear direction Y, and an up-down direction Z, as illustrated in the drawings. However, the battery system 101 may be installed in any orientation; for example, the up-down direction Z as defined herein may be oriented horizontally or longitudinally in actual installation or the left-right direction X as defined herein may be oriented longitudinally.

The battery packs 20 are each formed to have a rectangular-parallelepiped shape and are arranged side by side in the left-right direction X. Each battery pack 20 is, for example, a battery assembly including a plurality of battery cells (not shown) arranged in the front-rear direction Y. The plurality of battery cells are connected, for example, electrically in series or electrically in parallel. The outer surface portion of each battery pack 20 is made of a conductive material, such as metal. Each battery pack 20 may mainly include one battery cell, and for example, may include only one battery cell.

The acquisition devices 30 serving as second wireless communication devices or wireless communication devices are provided for the respective battery packs 20. Specifically, each acquisition device 30 is mounted on an outer upper surface 20u of the corresponding battery pack 20. Each acquisition device 30 includes, for example, a controller, a measurement circuit, a communication unit, and/or other peripheral devices (not shown). Each acquisition device 30 acquires battery information, i.e., information concerning the corresponding battery pack 20, from the corresponding battery pack 20. The battery information concerning each battery pack 20 includes, for example, (i) information about a voltage across each battery cell, (ii) information about temperature of each battery cell included in the corresponding battery pack 20, and (iii) information about a current flowing in the corresponding battery pack 20.

The monitoring device 40 serving as a first wireless communication device is installed in the housing 10, for example on an upper portion of a left inner side surface of the housing 10. The monitoring device 40 includes a controller, a communication unit, and/or other peripheral devices (not shown). The plurality of acquisition devices 30 and the monitoring device 40 perform wireless communication with one another using radio waves at a communication frequency f0 serving as a predetermined communication frequency. The communication frequency f0 is, for example, 2.4 GHz.

Through wireless communication with the acquisition devices 30, the monitoring device 40 transmits an acquisition instruction that instructs each acquisition device 30 to acquire, from the corresponding battery pack 20, the battery information related thereto, receives the battery information from each acquisition device 30, and transmits an equalization instruction that instructs each the acquisition device 30 to equalize the voltages across the respective battery cells included therein. The monitoring device 40 is also communicatively connected, wirelessly or by wire, to a higher-level ECU (not shown).

The housing 10 has a box shape that three-dimensionally surrounds a primary antenna 46 of the monitoring device 40 and secondary antennas 36 of the respective acquisition devices 30; each of the antennas 46 and 36 is configured to transmit and receive radio waves. As used herein, “surrounding three-dimensionally” means that an object to be surrounded is surrounded from six directions consisting of a positive side and a negative side in each of three mutually orthogonal directions. That is, the phrase that the primary antenna 46 or the secondary antenna 36 is “three-dimensionally surrounded” by the housing 10 means that wall portions or other structural members of the housing 10 are located on the respective six-directional sides of the primary antenna 46 or the secondary antenna 36. Thus, under the definition of “surrounding”, the housing 10 is allowed to have openings (e.g., screw holes, air vents, or connector holes) or other gaps.

The housing 10 has formed therein a first propagation path S1 between the monitoring device 40 and the leftmost battery pack 20 (the battery pack 20 closest to the monitoring device 40). The first propagation path S1 is a passage that is three-dimensionally surrounded by conductive material. In the first embodiment, the first propagation path S1 is defined by an inner upper surface 10u, an inner lower surface 10d, and a pair of front and rear inner side surfaces 10s of the housing 10. Among the three spatial directions, the cross-sectional dimension of the first propagation path S1 is smallest in the up-down direction Z. In other words, the distance between the inner upper surface 10u and the inner lower surface 10d of the housing 10 is smaller than the distance between the front and rear inner side surfaces 10s.

The housing 10 has formed therein a second propagation path S2, which is a radio-wave propagation path, between the outer upper surfaces 20u of the battery packs 20 and the inner upper surface 10u of the housing 10. The second propagation path S2 is a passage that is three-dimensionally surrounded by conductive material. In the first embodiment, the second propagation path S2 is defined by the inner upper surface 10u of the housing 10, the outer upper surfaces 20u of the battery packs 20, and the front and rear inner side surfaces 10s of the housing 10. Among the three spatial directions, the cross-sectional dimension of the second propagation path S2 is smallest in the up-down direction Z. In other words, the distance between the inner upper surface 10u of the housing 10 and the outer upper surface 20u of any battery pack 20 is smaller than the distance between the front and rear inner side surfaces 10s of the housing 10.

The monitoring device 40 is, for example, mounted on an upper middle portion of the left inner side surface of the housing 10 in the front-rear direction. The monitoring device 40 includes a main body and a primary antenna 46. The primary antenna 46 is used for wireless communication with the acquisition devices 30. The primary antenna 46 is mounted on, for example, a right side surface of the monitoring device 40. This results in the primary antenna 46 being arranged in the first propagation path S1. The monitoring device 40 has any height and any front-rear position in the first propagation path S1. The arrangement of the primary antenna 46 in the first propagation path S1 enables the main body (or a part of the main body) of the monitoring device 40 to be disposed at the boundary between the interior and the exterior of the housing 10, or to be disposed outside the housing 10 while only the primary antenna 46 is disposed inside the housing 10.

Each acquisition device 30 is installed in the housing 10 and mounted on, for example, a middle portion of the outer upper surface 20u of the corresponding battery pack 20 in the front-rear direction Y. Each acquisition device 30 includes a main body and a secondary antenna 36. The secondary antenna 36 is used for wireless communication with the monitoring device 40. Each secondary antenna 36 is arranged, for example, on the outer upper surface of the main body of the corresponding acquisition device 30. This results in each secondary antenna 36 to be disposed in the second propagation path S2. Each acquisition device 30 has any front-rear position in the second propagation path S2, and has any left-right position on the outer upper surface 20u of the corresponding battery pack 20 in the second propagation path S2.

As described above, the primary antenna 46 is disposed in the first propagation path S1 defined between an inner-wall portion of the housing 10 and the leftmost battery pack 20, and the secondary antennas 30 are disposed in the second propagation path S2 defined between the inner-wall portion of the housing 10 and the respective battery packs 20. Because the housing 10 and the outer surface of each battery pack 20 are made of a conductive material, boundary surfaces of the propagation paths S1 and S2 are formed of conductive materials that constitute the housing 10 and the outer surfaces of the battery packs 20. Accordingly, in wireless communication between the monitoring device 40 and the acquisition devices 30, the propagation paths S1 and S2 can be regarded in the same manner as waveguides for radio waves.

As illustrated in FIG. 4, in propagation of radio waves in a waveguide, radio waves having frequencies lower than a cutoff frequency of the waveguide are difficult to propagate, i.e., their propagation loss becomes large. For example, a cutoff wavelength λ is defined in accordance with the following formula (1) based on the width a and the height b of a cross section of the waveguide:

$$λ = 1 / \{ {( m / 2 a )}^{2} + {( n / 2 b )}^{2} \} \qquad ( 1 )$$

where:
m is the mode order (the number of half-wave patterns) in the height direction of the waveguide, and n represents the mode order (the number of half-wave patterns) in the width direction of the waveguide. A vertical-polarization cutoff frequency fv is defined in accordance with the following formula (2):

$$f v = c / λ v \qquad ( 2 )$$

where:
c represents the speed of light; and
λv represents the cutoff wavelength for vertical polarization.
The cutoff frequency for vertical polarization is lowest when m=1 and n=0.

The cut-off frequency fv for the lowest-order mode of vertical polarization is defined based on the above formulas (1) and (2), which is represented by the following formula:

$$f v = c / 2 a$$

Similarly, a horizontal-polarization cutoff frequency fh is defined in accordance with the following formula (3):

$$f v = c / λ h \qquad ( 3 )$$

where:
c represents the speed of light; and
λc represents the cutoff wavelength for horizontal polarization.

The cutoff frequency for horizontal polarization is lowest when m=0 and n=1.

The cut-off frequency fh for the lowest-order mode of horizontal polarization is defined based on the above formulas (1) and (3), which is represented by the following formula:

$$f h = c / 2 b$$

For example, when a=1000 mm and b=50 mm, the vertical-polarization cutoff frequency fv is 150 MHz and the horizontal-polarization cutoff frequency fh is 3 GHZ. If the communication frequency f0 is 2.4 GHz, then fv<f0, so vertical-polarization propagation loss can be reduced, whereas f0<fh, so horizontal polarization is difficult to propagate, in other words, horizontal-polarization propagation loss becomes large.

The present disclosure focuses on the fact that the cutoff frequencies fv and fh for vertical polarization and horizontal polarization in the first propagation path S1 in which the primary antenna 46 is arranged are respectively determined in accordance with the dimensions of the cross section of the first propagation path S1.

The present disclosure also focuses on the fact that the cutoff frequencies fv and fh for vertical polarization and horizontal polarization in the second propagation path S2 in which the secondary antennas 36 are arranged are respectively determined in accordance with the dimensions of the cross section of the second propagation path S2.

The present disclosure additionally focuses on the fact that each propagation path S1, S2 is designed such that the cutoff frequency fv for the lowest-order mode of vertical polarization is lower than the communication frequency f0. This enables radio waves having the communication frequency f0 and vertical polarization in at least the lowest-order mode to be propagated through the corresponding propagation path S1, S2 while propagation loss can be reduced.

The present disclosure additionally focuses on the fact that each propagation path S1, S2 is designed such that the cutoff frequency fh for the lowest-order mode of horizontal polarization is lower than the communication frequency f0. This enables radio waves having the communication frequency f0 and horizontal polarization in at least the lowest-order mode to be propagated through the corresponding propagation path S1, S2 while propagation loss can be reduced.

When the width a of the cross section of the propagation path S1 or S2 is greater than the height b (a>b), the cutoff frequency fv for radio waves with vertical polarization is lower than the cutoff frequency fh for radio waves with horizontal polarization (fv<fh). In this case, because radio waves with horizontal polarization propagate when their frequency is higher than the cutoff frequency fh, whereas radio waves with vertical polarization propagate when their frequency is higher than the cutoff frequency fv, which is lower than fh, the radio waves with vertical polarization is more likely propagate than the radio waves with horizontal polarization.

That is, the cutoff frequency fv for radio waves with vertical polarization, which corresponds to a polarization plane in a predetermined direction, is defined based on the width a of the cross section of the propagation path (i.e., the length of the cross section in the longitudinal direction), and is lower than the cutoff frequency for radio waves with horizontal polarization different from vertical polarization, which corresponds to a polarization plane in any direction other than the predetermined direction.

In this propagation path, because the width a of the cross section is greater than the height b, the cutoff frequency fv for radio waves with vertical polarization is lower than the cutoff frequency fh for radio waves with horizontal polarization. Thus, selecting, as radio waves with the communication frequency f0, radio waves with vertical polarization, which corresponds to the polarization plane in the predetermined direction, enables the cutoff frequency fv to be easily lower than the communication frequency f0. This results in the radio waves with vertical polarization propagating more easily through the propagation path than the radio waves with horizontal polarization, making it possible to suppress propagation loss. Additionally, the dimensions of the propagation path for radio waves can be designed in consideration of the above relationship among the communication frequency f0 and the cutoff frequencies fv and fh.

Accordingly, each of the monitoring device 40 and acquisition devices 30 mainly includes at least one antenna that transmits and receives radio waves having a polarization plane in a predetermined direction corresponding thereto more strongly than radio waves having polarization planes in directions other than the predetermined direction.

Specifically, the monitoring device 40 mainly includes at least one antenna that mainly transmits and receives radio waves having the vertical polarization plane more strongly than radio waves having polarization planes in any directions different from the vertical direction corresponding to the vertical polarization plane.

The following describes an example of an antenna 55 for vertical polarization that may be provided as the at least one antenna in the monitoring device 40.

As illustrated in FIGS. 22A to 22E, the antenna 55 for transmitting and receiving receives radio waves having the vertical-polarization plane is mounted to a circuit board 50 for wireless communication. The circuit board 50 includes a ground plate 51 and a power feeder 52 that feeds power to the antenna 55. The antenna 55 is formed in a wire shape. The antenna 55 includes a predetermined antenna portion 55a connected to the power feeder 52 and a predetermined antenna portion 55b connected to the ground plate 51. The predetermined portions 55a and 55b are provided in an upright state relative to the circuit board 50.

The upright state of each predetermined portion 55a, 55b relative to the circuit board 50 includes, for example, a state oriented perpendicularly to the circuit board 50, and a state inclined by several degrees from the perpendicular state. The ground plate 51 is located below the predetermined portions 55a and 55b.

As illustrated in FIGS. 23A to 23C, the antenna 55 for transmitting and receiving radio waves having the vertical-polarization plane may instead be formed in a plate shape. In this modification, the antenna 55 includes a predetermined antenna portion 55a connected to the power feeder 52, the predetermined portion 55a being provided in an upright state relative to the circuit board 50. An unillustrated ground plate is located below the predetermined portion 55a.

Additionally, as illustrated in FIGS. 24A and 24B, the antenna 55 for transmitting and receiving radio waves having the vertical-polarization plane may be a zeroth-order resonant antenna including a plate-shaped portion and a rod-shaped (linear) portion. In this modification, the antenna 55 includes a predetermined antenna portion 55a connected to the power feeder 52 and a predetermined antenna portion 55b connected to the ground plate 51. The predetermined antenna portion 55b is provided in an upright state relative to the circuit board 50. In other words, at least one of the predetermined portions 55a and 55b is provided in an upright state relative to the circuit board 50, and the ground plate 51 is located below the predetermined portions 55a and 55b.

Returning to FIGS. 1 to 3, the distance (length) in the front-rear direction Y between the front and rear inner side surfaces 10s of the housing 10 corresponds to the width of the cross section of the first propagation path S1 and is greater than the distance (length) in the up-down direction Z between the inner upper surface 10u and the inner lower surface 10d of the housing 10, which corresponds to the height of the cross section of the first propagation path S1. Accordingly, in the first propagation path S1, radio waves having the vertical polarization plane propagate more easily than radio waves having the horizontal polarization plane. Therefore, it is preferable to set the cutoff frequency fv defined based on the vertical polarization plane to be lower than the communication frequency f0, which enables radio waves having the vertical polarization plane at the communication frequency f0 to propagate more easily through the first propagation path S1.

More specifically, in the first propagation path S1, the cutoff frequency for radio waves having the vertical-polarization plane, which corresponds to a first polarization plane, is referred to as a first cutoff frequency f1, and the cutoff frequency for radio waves having the horizontal-polarization plane, which corresponds to a second polarization plane orthogonal to the first polarization plane, is referred to as a third cutoff frequency f3.

In the cross section of the first propagation path S1, the distance between the front and rear inner side surfaces 10s of the housing 10, which corresponds to the length of the housing 10 in the front-rear direction Y, is longer than the distance between the inner upper surface 10u and the inner lower surface 10d of the housing 10, which corresponds to the length of the housing 10 in the up-down direction Z.

This results in the first cutoff frequency f1 being lower than the third cutoff frequency f3 (f1<f3). The communication frequency f0 is set to be higher than both the first cutoff frequency f1 and the third cutoff frequency f3 (f1<f3<f0).

Each acquisition device 30 mainly includes at least one antenna that mainly transmits and receives radio waves having the vertical-polarization plane more strongly than radio waves having polarization planes in any directions different from the vertical direction corresponding to the vertical polarization.

The distance (length) in the front-rear direction Y between the front and rear inner side surfaces 10s of the housing 10 corresponds to the width of the cross section of the second propagation path S2 and is greater than the distance in the up-down direction Z between the inner upper surface 10u of the housing 10 and the outer upper surface 20u of any battery pack 20, which corresponds to the height of the cross section of the second propagation path S2. Accordingly, in the second propagation path S2, radio waves having the vertical polarization plane propagate more easily than radio waves having the horizontal polarization plane. Therefore, it is preferable to set the cutoff frequency fv defined based on the vertical polarization plane to be lower than the communication frequency f0, which enables radio waves having the vertical polarization plane at the communication frequency f0 to propagate more easily through the second propagation path S2.

More specifically, in the second propagation path S2, the cutoff frequency for radio waves having the vertical-polarization plane, which corresponds to the first polarization plane, is referred to as a second cutoff frequency f2, and the cutoff frequency for radio waves having the horizontal-polarization plane, which corresponds to the second polarization plane orthogonal to the first polarization plane, is referred to as a fourth cutoff frequency f4.

In the cross section of the second propagation path S2, the distance between the front and rear inner side surfaces 10s of the housing 10, which corresponds to the length of the housing 10 in the front-rear direction Y, is longer than the distance between the inner upper surface 10u of the housing 10 and the outer upper surface 20u of any battery pack 20, which corresponds to the length therebetween in the up-down direction Z.

This results in the second cutoff frequency f2 being lower than the fourth cutoff frequency f4 (f2<f4). The communication frequency f0 is higher than the second cutoff frequency f2 and lower than the fourth cutoff frequency f4 (f2<f0<f4).

That is, the polarization plane in the predetermined direction is configured such that the following cutoff frequencies are both lower than the communication frequency f0:
(i) the cutoff frequency f1 defined based on the length of the cross section of the first propagation path S1 in the longitudinal direction in which the primary antenna 46 is provided; and
(ii) the cutoff frequency f2 defined based on the length of the cross section of the second propagation path S2 in the longitudinal direction in which the second antennas 36 are provided.

The above first embodiment provides the following advantages.

The monitoring device 40 mainly includes the primary antenna 46 for transmitting and receiving radio waves having a polarization plane in the predetermined direction more strongly than radio waves having polarization planes in other directions, and each acquisition device 30 mainly includes the secondary antenna 36 for transmitting and receiving radio waves having a polarization plane in the predetermined direction more strongly than radio waves having polarization planes in other directions.

This configuration therefore makes it possible to reduce, as much as possible, the number of primary and secondary antennas 46 and 36 included in the devices 40 and 30 as compared with a comparative example where the monitoring device 40 includes primary antennas for transmitting and receiving radio waves having polarization planes in multiple directions and each secondary device 30 includes secondary antennas for transmitting and receiving radio waves having polarization planes in multiple directions.

Additionally, each propagation path S1 and S2 is configured such that the cutoff frequency for radio waves having the polarization plane in the predetermined direction is lower than the communication frequency f0.

Therefore, wireless communication using radio waves having the polarization plane in the predetermined direction makes it possible to reduce the cutoff frequency to be lower than the communication frequency f0 for each of the monitoring device 40 and the acquisition devices 30, thus suppressing propagation loss. This improves the communication reliability in the battery system 101.

In particular, the monitoring device 40 can be configured to include only the single primary antenna 46 for transmitting and receiving radio waves that have the polarization plane in the predetermined direction more strongly than radio waves having polarization planes in any directions different from the predetermined direction, and each acquisition unit 30 can be configured to include only the single secondary antenna 36 for transmitting and receiving radio waves that have the polarization plane in the predetermined direction more strongly than radio waves having polarization planes in any directions different from the predetermined direction. This minimizes the number of primary secondary antennas 46 and 36.

The communication frequency f0 used for wireless communication in the first propagation path S1 is set to be higher than both the first cutoff frequency f1 for radio waves having the first polarization plane and the third cutoff frequency f3 for radio waves having the second polarization plane.

This therefore makes it possible to reduce propagation loss in wireless communication in the first propagation path S1 even if the wireless communication uses radio waves having any one of the first polarization plane and the second polarization plane.

Additionally, the communication frequency f0 used for wireless communication in the second propagation path S2 is set to be higher than the second cutoff frequency f2 for radio waves having the first polarization plane and lower than the fourth cutoff frequency f4 for radio waves having the second polarization plane.

This therefore makes it possible to reduce propagation loss in wireless communication in the second propagation path S2 when radio waves having the first polarization plane, which corresponds to the polarization plane in the predetermined direction, are used instead of the usage of radio waves having the second polarization plane.

Accordingly, the monitoring device 40 mainly includes the primary antenna 46 for transmitting and receiving radio waves having the first polarization plane and each acquisition device 30 mainly includes the secondary antenna 36 for transmitting and receiving radio waves having the first polarization plane, which makes it possible to maintain communication reliability through each of the first and second propagation paths S1 and S2.

In particular, the monitoring device 40 mainly includes the primary antenna 46 for transmitting and receiving radio waves having the vertical polarization plane as the first polarization plane and each acquisition device 30 mainly includes the secondary antenna 36 for transmitting and receiving radio waves having the vertical polarization plane as the first polarization plane, which makes it possible to maintain communication reliability through each of the first and second propagation paths S1 and S2.

Wireless connection between the monitoring device 40 and each acquisition device 30 simplifies reuse of the battery packs 20 while reducing component count and high-voltage handling compared to wired connections therebetween.

The first embodiment may be modified as follows. To components of the following modified examples, which are identical to those of the first embodiment, the same reference characters are assigned, and the same descriptions thereof can be employed.

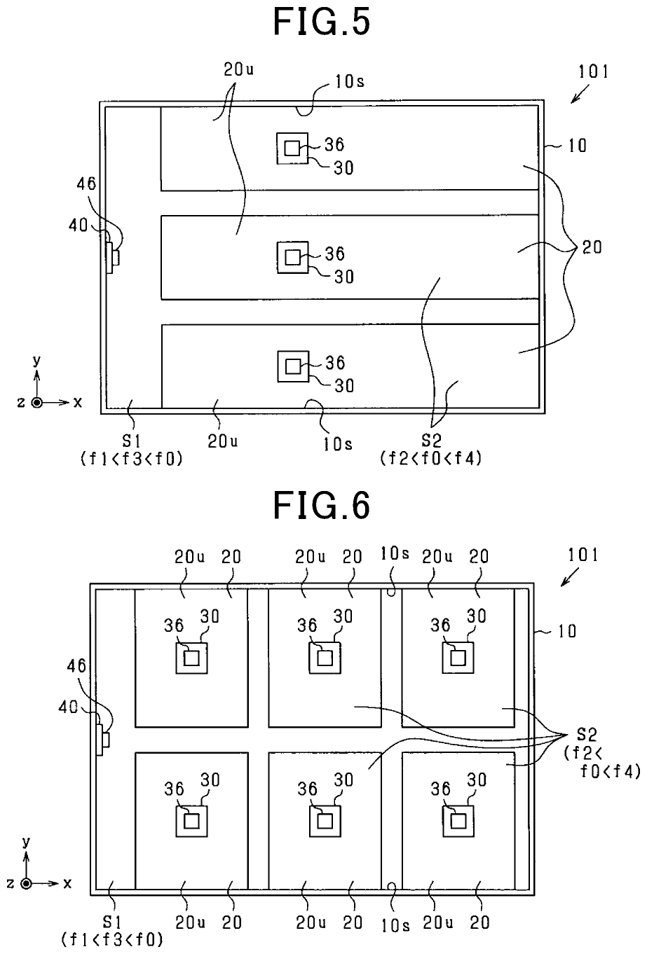

As illustrated in the plan view of FIG. 5, the battery packs 20, each of which has a rectangular-parallelepiped shape, may be arranged side by side in the front-rear direction Y. Additionally, as illustrated in the plan view of FIG. 6, the battery packs 20, each of which has a rectangular-parallelepiped shape, may be arranged side by side in both the left-right direction X and the front-rear direction Y. The first propagation path S1 and the second propagation path S2 according to each of the modified examples have respectively the same configurations as those according to the first embodiment. That is, the primary antenna 46 according to each modified example is disposed in the first propagation path S1, and the secondary antennas 36 according to each modified example are disposed in the second propagation path S2. The monitoring device 40 according to each modified example mainly includes the primary antenna 46 for transmitting and receiving radio waves having the vertical polarization plane as the first polarization plane. Each acquisition device 30 according to each modified example mainly includes the secondary antenna 36 for transmitting and receiving radio waves having the vertical polarization plane as the first polarization plane.

The above configuration of each modified example also provides advantages similar to those of the first embodiment.

### Second Embodiment

The following describes the second embodiment mainly with respect to differences from the first embodiment. In particular, each acquisition device 30 is mounted on an outer side surface, such as a front outer side surface 20s of the corresponding battery pack 20. To components of the second embodiment, which are identical to those of the first embodiment, the same reference characters are assigned, and the same descriptions thereof can be employed.

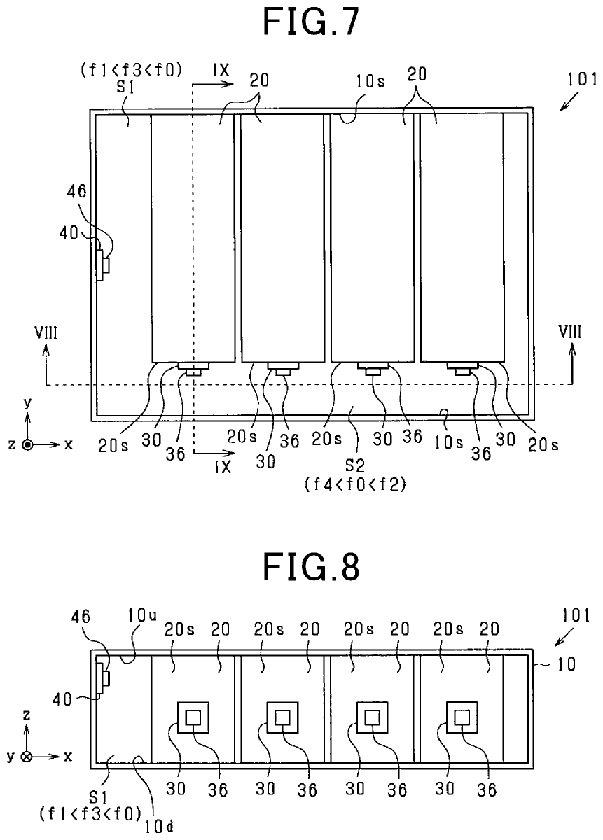

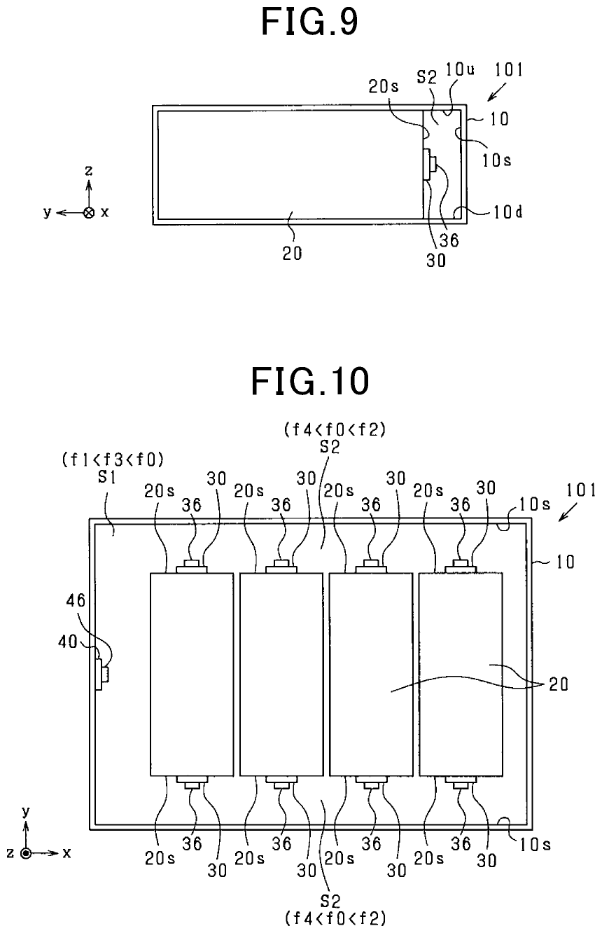

FIG. 7 is a plan view of the battery system 101, FIG. 8 is a sectional view taken along line VIII-VIII of FIG. 7, and FIG. 9 is a sectional view taken along line IX-IX of FIG. 7. In FIG. 7, the upper wall portion of the housing 10 is omitted.

The acquisition devices 30, each of which serves as a second wireless communication device or a wireless communication device, are provided for the respective battery packs 20. Specifically, each acquisition device 30 is mounted on the front outer side surface 20s of the corresponding battery pack 20.

The monitoring device 40, which serves as a first wireless communication device or a wireless communication device, is arranged similarly to the monitoring device 40 of the first embodiment. However, the primary antenna 46 of the second embodiment differs from that of the first embodiment, as described below.

The housing 10 is identical to that of the first embodiment. The first propagation path S1 is identical to that of the first embodiment.

The housing 10 has formed therein a second propagation path S2, which is a radio-wave propagation path, between the front outer side surfaces 20s of the battery packs 20 and a front inner side surface 10u of the housing 10. The second propagation path S2 is a passage that is three-dimensionally surrounded by conductive material. In the second embodiment, the second propagation path S2 is defined by the inner upper surface 10u and an inner lower surface 10d of the housing 10, the front outer side surfaces 20s of the battery packs 20, and the front inner side surface 10s of the housing 10. Among the three spatial directions, the cross-sectional dimension of the second propagation path S2 is smallest in the front-rear direction Y. In other words, the distance between the inner upper surface 10u and the inner lower surface 10d of the housing 10 is greater than the distance between the front outer side surface 20 of any battery pack 20 and the front inner side surface 10s of the housing 10.

Each acquisition device 30 is installed in the housing 10 and mounted on, for example, a middle portion of the front outer side surface 20s of the corresponding battery pack 20 in the left-right direction X. Each acquisition device 30 includes a main body and a secondary antenna 36. The secondary antenna 36 is used for wireless communication with the monitoring device 40. Each secondary antenna 36 is arranged, for example, on the corresponding front outer side surface of the main body of the corresponding acquisition device 30. This results in each secondary antenna 36 to be disposed in the second propagation path S2. Each acquisition device 30 has any front-rear position in the second propagation path S2, and has any up-down position on the front outer side surface 202 of the corresponding battery pack 20 in the second propagation path S2, and has any left-right position on the front outer side surface 20s of the corresponding battery pack 20 in the second propagation path S2.

As described above, the primary antenna 46 is disposed in the first propagation path S1 defined between the inner-wall portion of the housing 10 and the leftmost battery pack 20, and the secondary antennas 30 are disposed in the second propagation path S2 defined between the inner-wall portion of the housing 10 and the respective battery packs 20. Therefore, like the first embodiment, in wireless communication between the monitoring device 40 and the acquisition devices 30 of the second embodiment, the propagation paths S1 and S2 can be regarded in the same manner as waveguides for radio waves.

That is, each of the monitoring device 40 and acquisition devices 30 mainly includes at least one antenna that transmits and receives radio waves having a polarization plane in a predetermined direction corresponding thereto more strongly than radio waves having polarization planes in directions other than the predetermined direction.

Specifically, the monitoring device 40 according to the second embodiment mainly includes at least one antenna that mainly transmits and receives radio waves having the horizontal polarization plane more strongly than radio waves having polarization planes in any directions different from the horizontal direction corresponding to the horizontal polarization plane.

In the first propagation path S1, the cutoff frequency for radio waves having the vertical-polarization plane, which corresponds to a first polarization plane, is referred to as the first cutoff frequency f1, and the cutoff frequency for radio waves having the horizontal-polarization plane, which corresponds to a second polarization plane orthogonal to the first polarization plane, is referred to as the third cutoff frequency f3. Like the first embodiment, the communication frequency f0 is set to be higher than both the first cutoff frequency f1 and the third cutoff frequency f3 (f1<f3<f0).

Each acquisition device 30 mainly includes at least one antenna that mainly transmits and receives radio waves having the horizontal-polarization plane more strongly than radio waves having polarization planes in any directions different from the horizontal direction corresponding to the horizontal polarization.

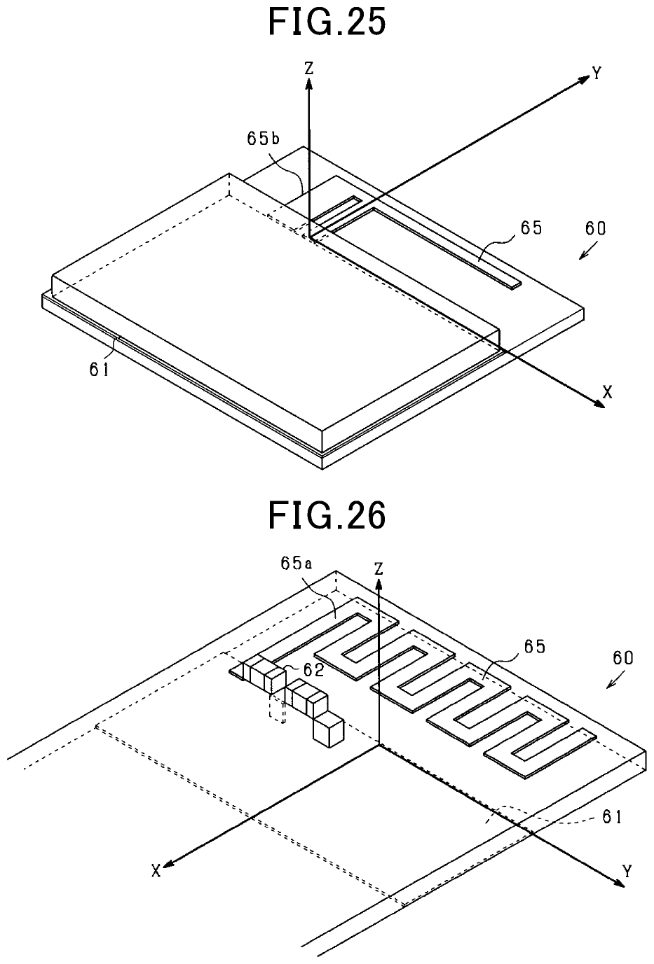

As illustrated in each of FIGS. 25 and 26, an antenna 65 for transmitting and receiving radio waves having the horizontal-polarization plane is mounted to a circuit board 60 for wireless communication. The circuit board 60 includes a ground plate 61 and a power feeder 62 that feeds power to the antenna 65. The antenna 65 is formed in a plate shape. The antenna 65 includes a predetermined first antenna portion connected to the power feeder 62 and/or a predetermined second antenna portion connected to the ground plate 61.

In the example illustrated in FIG. 25, the antenna 65 includes an antenna portion (see reference character 65b) illustrated in FIG. 25. The antenna portion 65b of the antenna 65 is located over an exposed portion of the circuit board 60 below which no ground plate 61 is present, and extends along the circuit board 60 (see FIG. 25).

Moreover, in the example illustrated in FIG. 26, the antenna 65 includes an antenna portion (see reference character 65a). The antenna portion 65a of the antenna 65 is located over an exposed portion of the circuit board 60 below which no ground plate 61 is present, and extends along the circuit board 60 (see FIG. 26).

Returning to FIGS. 7 to 9, the distance (length) in the up-down direction Z between the inner upper and lower surfaces 10u and 10d of the housing 10, which corresponds to the height of the cross section of the second propagation path S2 is greater than the distance in the front-rear direction Y between the front inner side surface 10s of the housing 10 and the front outer side surface 20s of any battery pack 20, which corresponds to the width of the cross section of the second propagation path S2. Accordingly, in the second propagation path S2, radio waves having the horizontal polarization plane propagate more easily than radio waves having the vertical polarization plane. Therefore, it is preferable to set the cutoff frequency fh defined based on the horizontal polarization plane to be lower than the communication frequency f0, which enables radio waves having the horizontal polarization plane at the communication frequency f0 to propagate more easily through the second propagation path S2.

In the second propagation path S2, the cutoff frequency fh for the horizontal polarization plane is lower than the communication frequency f0. This cutoff frequency fh is determined based on the length of the cross section of the second propagation path S2 in the longitudinal direction corresponding to the up-down direction Z; each secondary antenna 36 is provided in the second propagation path S2.

More specifically, in the second propagation path S2, the cutoff frequency for radio waves having the vertical-polarization plane, which corresponds to the first polarization plane, is referred to as the second cutoff frequency f2, and the cutoff frequency for radio waves having the horizontal-polarization plane, which corresponds to the second polarization plane orthogonal to the first polarization plane, is referred to as the fourth cutoff frequency f4. In the cross section of the second propagation path S2, the distance between the inner upper and lower surfaces 10u and 10d of the housing 10, which corresponds to the length of the housing 10 in the up-down direction Z, is longer than the distance between the front inner side surface 10s of the housing 10 and the front outer side surface 20s of any battery pack 20, which corresponds to the length therebetween in the front-rear direction Y.

This results in the fourth cutoff frequency f4 being lower than the second cutoff frequency f2 (f4<f2). The communication frequency f0 is higher than the fourth cutoff frequency f4 and lower than the second cutoff frequency f2 (f4<f0<f2).

That is, the polarization plane in the predetermined direction is configured such that the following cutoff frequencies are both lower than the communication frequency f0:
(i) the cutoff frequency f1 defined based on the length of the cross section of the first propagation path S1 in the longitudinal direction in which the primary antenna 46 is provided;
(ii) the cutoff frequency f4 defined based on the length of the cross section of the second propagation path S2 in the longitudinal direction in which the second antennas 36 are provided; and
(iii) the cutoff frequency f3 defined based on the length of the cross section of the first propagation path S1.

The above second embodiment provides the following advantages.

The communication frequency f0 used for wireless communication in the first propagation path S1 is set to be higher than both the first cutoff frequency f1 for radio waves having the first polarization plane and the third cutoff frequency f3 for radio waves having the second polarization plane.

This therefore makes it possible to reduce propagation loss in wireless communication in the first propagation path S1 even if the wireless communication uses radio waves having any one of the first polarization plane and the second polarization plane.

Additionally, the communication frequency f0 used for wireless communication in the second propagation path S2 is set to be lower than the second cutoff frequency f2 for radio waves having the first polarization plane and higher than the fourth cutoff frequency f4 for radio waves having the second polarization plane.

That is, using radio waves having the second polarization plane, which corresponds to the polarization plane in the predetermined direction, for wireless communication in the second propagation path S2 makes it possible to reduce propagation loss rather than using radio waves having the first polarization plane.

Accordingly, each acquisition device 30 mainly includes the secondary antenna 36 for transmitting and receiving radio waves having the second polarization plane, which makes it possible to maintain communication reliability through the second propagation path S2.

In particular, the monitoring device 40 mainly includes the primary antenna 46 for transmitting and receiving radio waves having the horizontal polarization plane as the second polarization plane and each acquisition device 30 mainly includes the secondary antenna 36 for transmitting and receiving radio waves having the horizontal polarization plane as the second polarization plane, which makes it possible to maintain communication reliability through each of the first and second propagation paths S1 and S2.

The second embodiment may be modified as follows. To components of the following modified examples, which are identical to those of the second embodiment, the same reference characters are assigned, and the same descriptions thereof can be employed.

As illustrated in the plan view of FIG. 10, the acquisition devices 30 may be mounted on both the front outer side surface 20s and a rear outer side surface 20s of each battery pack 20 according to a first modified example. The first propagation path S1 and the second propagation path S2 according to the first modified example have respectively the same configurations as those according to the second embodiment.

That is, the second propagation path S2 according to the first modified example is defined by the inner upper surface 10u and the inner lower surface 10d of the housing 10, the front outer side surfaces 20s of the battery packs 20, and the front inner side surface 10s of the housing 10. The primary antenna 46 according to the first modified example is disposed in the first propagation path S1, and the secondary antennas 36 according to the first modified example are disposed in the second propagation path S2. The monitoring device 40 according to the first modified example mainly includes the primary antenna 46 for transmitting and receiving radio waves having the horizontal polarization plane as the second polarization plane. Each acquisition device 30 according to the first modified example mainly includes the secondary antenna 36 for transmitting and receiving radio waves having the horizontal polarization plane as the second polarization plane.

The above configuration of the first modified example also provides advantages similar to those of the second embodiment.

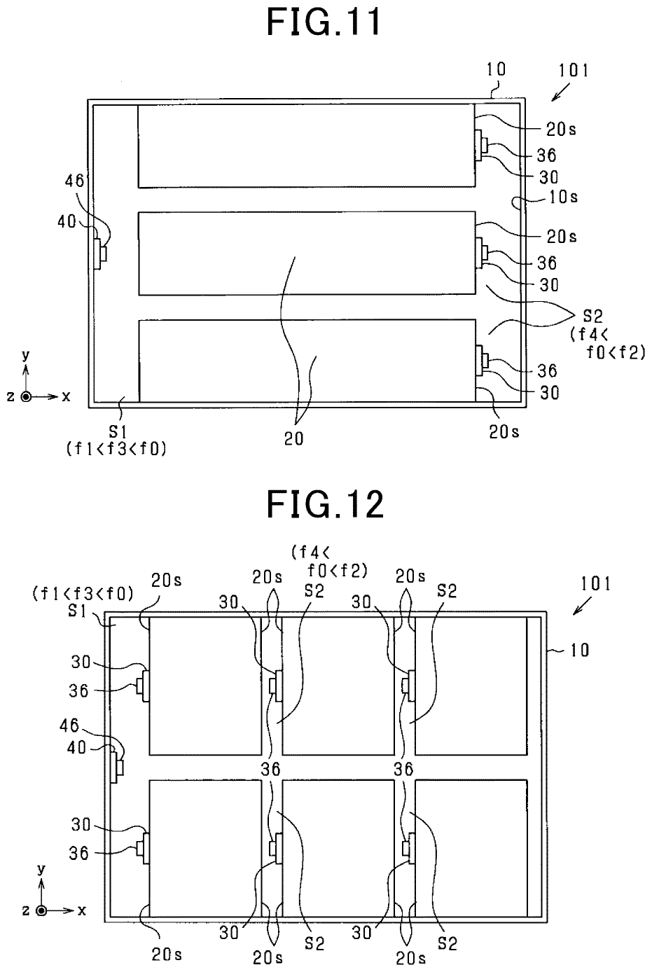

As illustrated in the plan view of FIG. 11, the battery packs 20, each of which has a rectangular-parallelepiped shape, may be arranged side by side in the front-rear direction Y, and each acquisition device 30 may be mounted on a right outer side surface 20s of the corresponding battery pack 20 according to a second modified example. The first propagation path S1 according to the second modified example has the same configurations as that according to the second embodiment.

The second propagation path S2 according to the second modified example is defined by the inner upper surface 10u and the inner lower surface 10d of the housing 10, the right outer side surfaces 20s of the battery packs 20, and a right inner side surface 10s of the housing 10.

In the cross section of the second propagation path S2 according to the second modified example, the distance between the inner upper and lower surfaces 10u and 10d of the housing 10, which corresponds to the length of the housing 10 in the up-down direction Z, is longer than the distance between the right inner side surface 10s of the housing 10 and the right outer side surface 20s of any battery pack 20, which corresponds to the length therebetween in the left-right direction X. This results in the fourth cutoff frequency f4 being lower than the second cutoff frequency f2 (f4<f2). The communication frequency f0 is higher than the fourth cutoff frequency f4 and lower than the second cutoff frequency f2 (f4<f0<f2). The primary antenna 46 according to the second modified example is disposed in the first propagation path S1, and the secondary antennas 36 according to the second modified example are disposed in the second propagation path S2. The monitoring device 40 according to the second modified example mainly includes the primary antenna 46 for transmitting and receiving radio waves having the horizontal polarization plane as the second polarization plane. Each acquisition device 30 according to the second modified example mainly includes the secondary antenna 36 for transmitting and receiving radio waves having the horizontal polarization plane as the second polarization plane.

The above configuration of the second modified example provides advantages similar to those of the second embodiment.

As illustrated in the plan view of FIG. 12, the battery packs 20, each of which has a rectangular-parallelepiped shape, may be arranged side by side in both the left-right direction X and the front-rear direction Y, and each acquisition device 30 may be mounted on a left outer side surface 20s of the corresponding battery pack 20 according to a third modified example. The first propagation path S1 according to the third modified example has the same configurations as that according to the second embodiment.

The second propagation path S2 according to the third modified example is defined by the inner upper and lower surfaces 10u and 10d of the housing 10 and the right and left outer side surfaces 20s of the battery packs 20.

In the cross section of the second propagation path S2 according to the third modified example, the distance between the inner upper and lower surfaces 10u and 10d of the housing 10, which corresponds to the length of the housing 10 in the up-down direction Z, is longer than the distance between the left and right outer side surface 20s of any battery pack 20, which corresponds to the length therebetween in the left-right direction X. This results in the fourth cutoff frequency f4 being lower than the second cutoff frequency f2 (f4<f2). The communication frequency f0 is higher than the fourth cutoff frequency f4 and lower than the second cutoff frequency f2 (f4<f0<f2). The primary antenna 46 according to the third modified example is disposed in the first propagation path S1, and the secondary antennas 36 according to the third modified example are disposed in the second propagation path S2. The monitoring device 40 according to the third modified example mainly includes the primary antenna 46 for transmitting and receiving radio waves having the horizontal polarization plane as the second polarization plane. Each acquisition device 30 according to the third modified example mainly includes the secondary antenna 36 for transmitting and receiving radio waves having the horizontal polarization plane as the second polarization plane.

The above configuration of the third modified example provides advantages similar to those of the second embodiment.

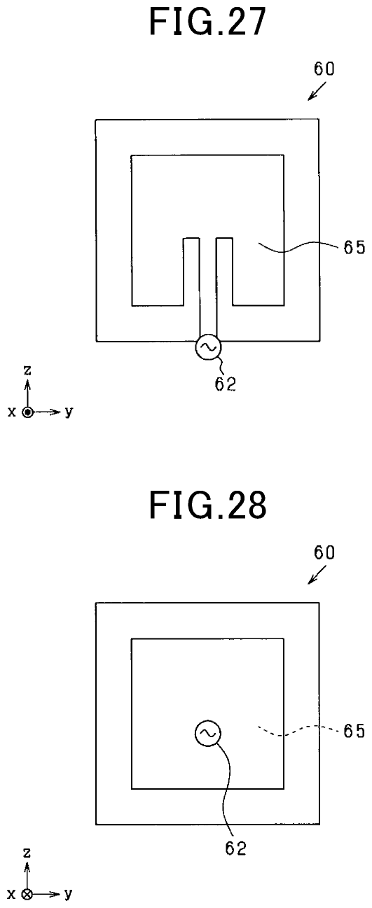

As illustrated in each of FIGS. 27 and 28, the monitoring device 40 may include the antenna 65 corresponding to the primary antenna 46, and the circuit board 60 including the power feeder 62. The power feeder 62 may be mounted on either a front surface or a rear surface of the circuit board 60. The antenna 65 (and the circuit board 60) may be disposed to be inclined relative to a horizontal plane. The monitoring device 40 mainly transmits and receives, through the antenna 65, radio waves having an oblique polarization plane.

Similarly, each acquisition unit 30 may include the antenna 65 corresponding to the secondary antenna 36, and mainly transmit and receives, through the antenna 65, radio waves having the oblique polarization plane.

The battery system 101 according to each of the modifications illustrated in FIGS. 27 and 28 may be installed in any orientation. In each of the modifications illustrated in FIGS. 27 and 28, each of the monitoring device 40 and acquisition devices 30 mainly includes at least one antenna that transmits and receives radio waves having the polarization plane in the predetermined direction corresponding thereto more strongly than radio waves having polarization planes in directions other than the predetermined direction. That is, the polarization plane in the predetermined direction is configured such that the following cutoff frequencies are both lower than the communication frequency f0:
(i) the cutoff frequency f1 defined based on the length of the cross section of the first propagation path S1 in the longitudinal direction in which the primary antenna 46 is provided; and
(ii) the cutoff frequency f2 defined based on the length of the cross section of the second propagation path S2 in the longitudinal direction in which the second antennas 36 are provided.

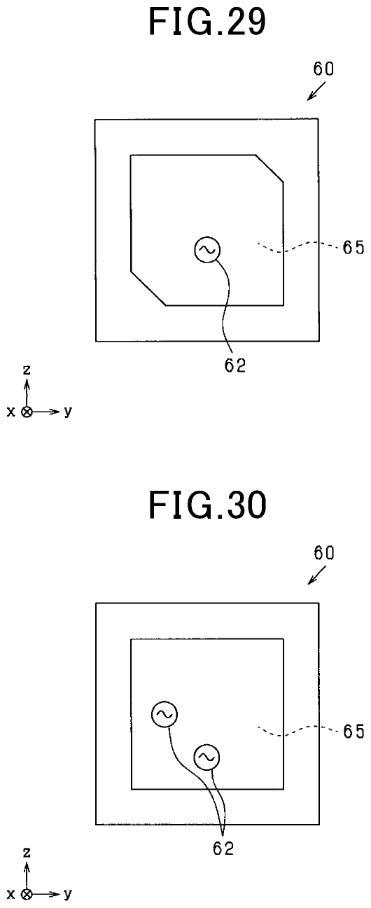

Additionally, as illustrated in each of FIGS. 29 and 30, the monitoring device 40 may include the antenna 65 corresponding to the primary antenna 46, and the circuit board 60 including one or more power feeders 62. The monitoring device 40 mainly transmits and receives, through the antenna 65, radio waves having an oblique polarization plane. A single power feeder 62 may be mounted on the rear surface of the circuit board 60 or two power feeder 62 may be mounted on the rear surface of the circuit board 60. Note that the one or more power feeders 62 may supply power to the antenna 65 using, for example, electromagnetic coupling.

Similarly, each acquisition unit 30 may include the antenna 65 corresponding to the secondary antenna 36, and mainly transmit and receive, through the antenna 65, radio waves having the circular polarization plane.

In each of the modifications illustrated in FIGS. 29 and 30, each of the monitoring device 40 and acquisition devices 30 mainly includes at least one antenna that transmits and receives radio waves having the polarization plane in the predetermined direction corresponding thereto more strongly than radio waves having polarization planes in directions other than the predetermined direction. That is, the polarization plane in the predetermined direction is configured such that the following cutoff frequencies are both lower than the communication frequency f0:
(i) the cutoff frequency f1 defined based on the length of the cross section of the first propagation path S1 in the longitudinal direction in which the primary antenna 46; and
(ii) the cutoff frequency f2 defined based on the length of the cross section of the second propagation path S2 in the longitudinal direction in which the second antennas 36.

### Third Embodiment

The following describes the third embodiment mainly with respect to differences from the second embodiment. In particular, a predetermined additional propagation path is present between the primary antenna 46 and the secondary antennas 36, and the predetermined additional propagation path results in polarization rotation in radio waves transmitted from the primary antenna 46 and/or any secondary antenna 36. To components of the third embodiment, which are identical to those of the second embodiment, the same reference characters are assigned, and the same descriptions thereof can be employed.

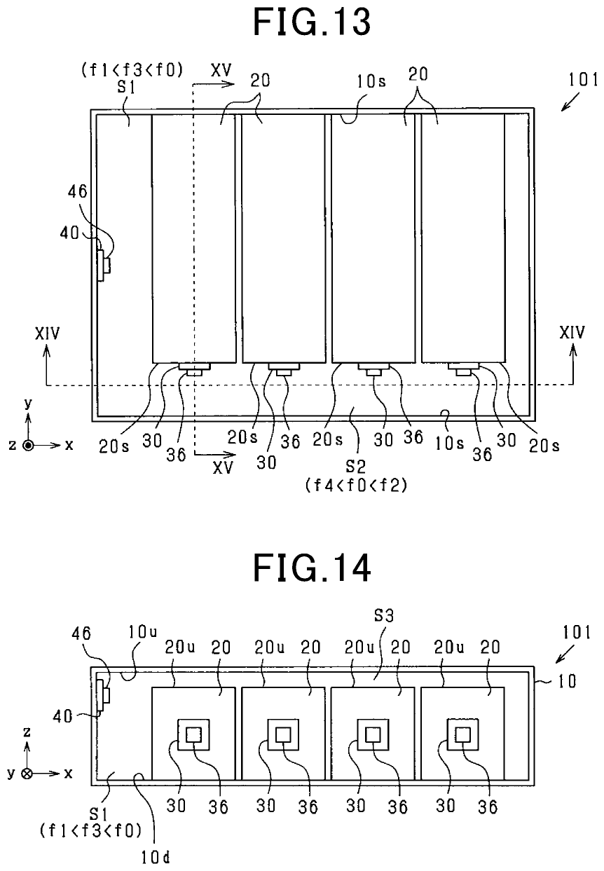

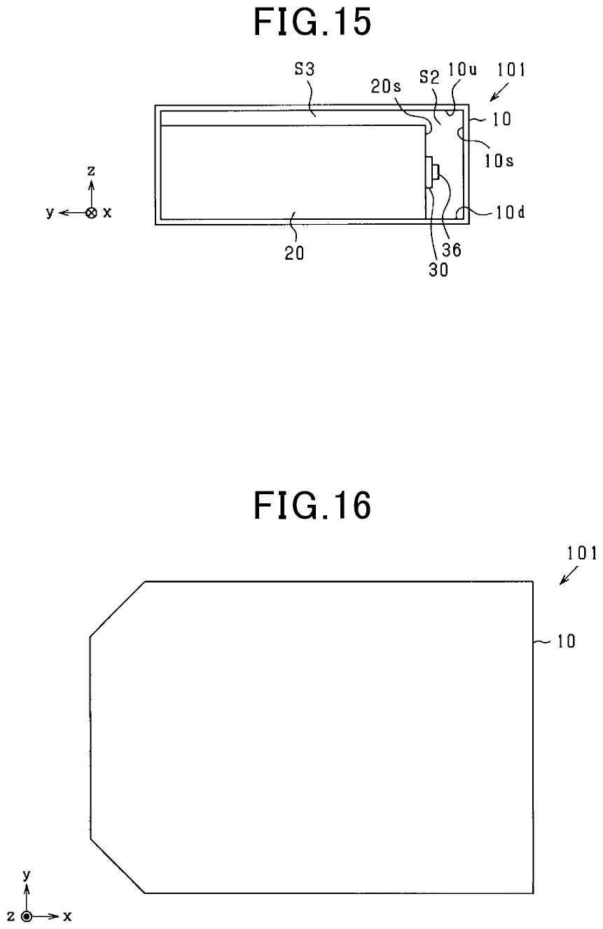

FIG. 13 is a plan view of the battery system 101, FIG. 14 is a sectional view taken along line XIV-XIV of FIG. 13, and FIG. 15 is a sectional view taken along line XV-XV of FIG. 13. In FIG. 13, the upper wall portion of the housing 10 is omitted.

The acquisition devices 30, each of which serves as a second wireless communication device or a wireless communication device, have respectively the same configurations as those of the second embodiment.

The monitoring device 40, which serves as a first wireless communication device or a wireless communication device, is arranged similarly to the monitoring device 40 of the first embodiment.

In particular, the primary antenna 46 of the third embodiment is adapted in consideration of polarization rotation, as described later.

The housing 10 is identical to that of the second embodiment.

The first propagation path S1 is identical to that of the second embodiment.

The housing 10 has formed therein the predetermined additional propagation path between the primary antenna 46 and the secondary antennas 36, which results in polarization rotation in radio waves transmitted from the primary antenna 46 and/or any secondary antenna 36.

The predetermined additional propagation path includes a third propagation path S3 defined by the inner upper surface 10u, the outer upper surfaces 20u of the battery packs 20, and the inner front and rear side surfaces 10s of the housing 10. In the third propagation path S3, the distance between the inner upper surface 10u and the outer upper surface 20u of any battery pack 20 is smaller than the distance between the inner front and rear side surfaces 10s of the housing 10.

In this case, radio waves transmitted from, for example, the primary antenna 46 reach the secondary antennas 36 in the second propagation path S2 from the first propagation path S1 via the third propagation path S3. The radio waves, which have the second polarization plane transmitted from the primary antenna 46, may undergo polarization rotation in the third propagation path S3, resulting in the radio waves, which have the second polarization plane, being changed into radio waves having the first polarization plane at the position of at least one secondary antenna 36.

In the first propagation path S1, the communication frequency f0 is set to be higher than the first cutoff frequency f1 for radio waves having the first polarization plane and higher than the third cutoff frequency f3 for radio waves having the second polarization plane. Wireless communication to the primary antenna 46 from any secondary antenna 36 using either radio waves having the first polarization plane or radio waves having the second polarization plane can be carried out while suppressing propagation loss.

Additionally, in the second propagation path S2, the communication frequency f0 is set to be lower than the second cutoff frequency f2 for radio waves having the first polarization plane and higher than the fourth cutoff frequency f4 for radio waves having the second polarization plane. For this reason, using radio waves having the second polarization plane for wireless communication from the primary antenna 46 to any secondary antenna 36 results in, at least the position of the secondary antenna 36, lower propagation loss rather than using the first polarization plane.

From this viewpoint, the direction of the polarization plane of radio waves to be transmitted from the primary antenna 46 is selected such that, after propagation of the radio waves through the first, third, and second propagation paths S1, S3, and S2 in this order, the radio waves as received at the position of any secondary antenna 36 to have a polarization plane in the predetermined direction, i.e., a horizontal-polarization plane.

That is, the monitoring device 40 according to the second embodiment mainly includes at least one primary antenna 46 that mainly transmits and receives radio waves having the polarization plane with the selected direction that enables the radio waves as received at the position of any secondary antenna 36 to have the polarization plane in the predetermined direction, i.e., the horizontal-polarization plane.

Each acquisition device 30 mainly includes at least one antenna as the at least one secondary antenna 36 that mainly transmits and receives radio waves having the horizontal-polarization plane more strongly than radio waves having polarization planes in any directions different from the horizontal direction corresponding to the horizontal polarization.

The above third embodiment provides the following advantages.

As described above, in the second propagation path S2, more specifically at the positions of the respective secondary antennas 36 in the second propagation path S2, propagation loss of radio waves having the second polarization plane, that is, radio waves having the polarization plane in the predetermined direction, can be reduced. Accordingly, even when each acquisition device 30 mainly includes the secondary antenna 36 that transmits and receives radio waves having the second polarization plane more strongly than radio waves having other-directional polarization planes, and the monitoring device 40 mainly includes the primary antenna 46 that transmits and receives radio waves that become the second polarization plane at the positions of the respective secondary antennas 36, the above configuration makes it possible to maintain communication reliability through the propagation path S2.

The monitoring device 40 mainly includes the primary antenna 46 that transmits and receives radio waves that become the horizontal polarization plane at the positions of the respective secondary antennas 36, making it possible to maintain communication reliability related to the monitoring device 40.

The first to third embodiments and their modified examples may be modified as follows. To components of the following modifications, which are identical to those of the first to third embodiments and their modified examples, the same reference characters are assigned, and the same descriptions thereof can be employed.

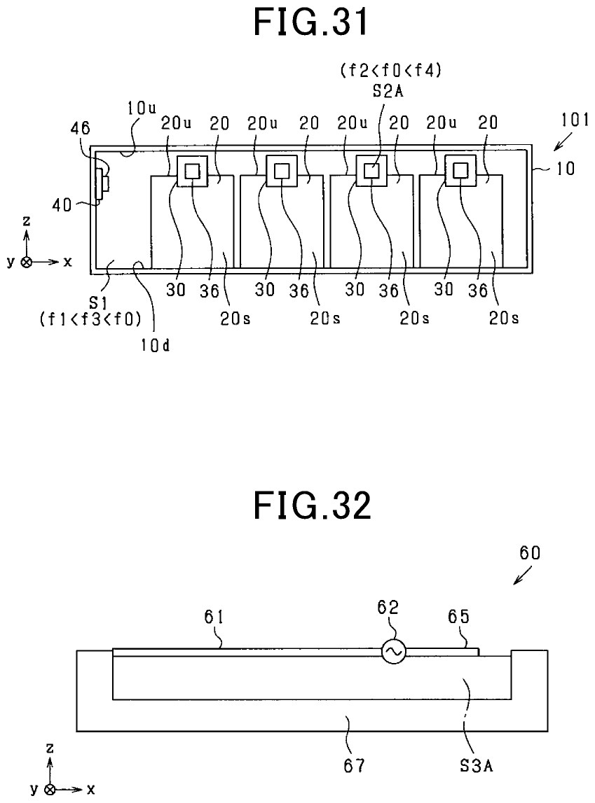

The configuration of the battery system 101 illustrated in FIGS. 13 to 15 may be modified as that illustrated in FIG. 31.

In this modification, each acquisition device 30 is disposed in the housing 10 so as to project upward beyond the upper ends of the front outer side surfaces 20s of the corresponding battery pack 20 in the up-down direction Z. This results in the portion of each secondary antenna 36 being substantially located in a second propagation path S2A through which radio waves are mainly propagated toward and/or from the corresponding secondary antenna 36.

That is, like the first embodiment, the monitoring device 40 of this modification mainly includes at least one primary antenna 46 disposed in the first propagation path S1 for transmitting and receiving radio waves having the first polarization plane, i.e., the vertical polarization plane, and each acquisition device mainly includes at least one secondary antenna 36 disposed in the second propagation path S2A for transmitting and receiving radio waves having the first polarization plane, i.e., the vertical polarization plane. In this respect, the second propagation path S2A functionally corresponds to the second propagation path S2 of the first embodiment.

Here, a propagation path in which the primary antenna 46 is disposed means the propagation path in which the portion of the primary antenna 46 that transmits and receives radio waves is substantially located, and a propagation path in which each secondary antenna 36 is disposed means the propagation path in which the portion of the corresponding secondary antenna 36 that transmits and receives radio waves is substantially located.

The housing 10 may have a box shape in which both corners at the left end are chamfered, as shown in the plan view of FIG. 16 according to a first modification.

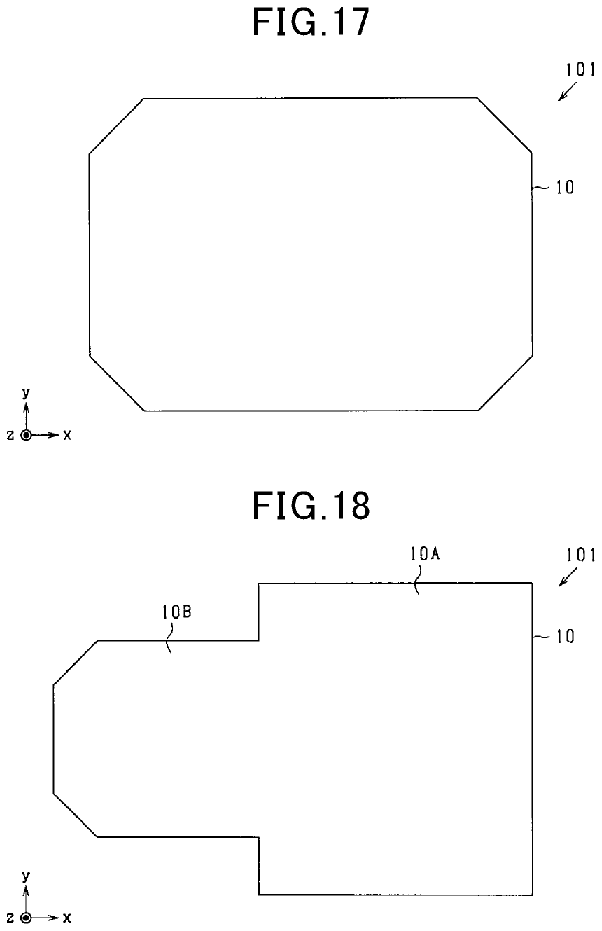

The housing 10 may have a box shape in which all corners are chamfered, as shown in the plan view of FIG. 17 according to a second modification.

As illustrated in FIG. 18, the housing 10 may have a substantially T-shaped box configuration including a first portion 10A and a second portion 10B that extends therefrom and is smaller than the first portion 10A according to a third modification. Both corners at the left end of the second portion 10B, which is opposite to the right end thereof joined to the first portion 10A, may be chamfered.

Each of the monitoring device 40 and the acquisition devices 30 according to each of the first to third modifications mainly includes at least one antenna that more strongly transmits and receives radio waves having they polarization plane in the corresponding predetermined direction. That is, the polarization plane in the predetermined direction is configured such that the following cutoff frequencies are both lower than the communication frequency f0:
(i) the cutoff frequency defined based on the length of the cross section of the propagation path in the longitudinal direction in which the at least one primary antenna 46 is provided; and
(ii) the cutoff frequency defined based on the length of the cross section of the propagation path in the longitudinal direction in which the second antennas 36 are provided.

The monitoring device 40 may include the circuit board 65 and a bracket 67. The antenna 65, the ground plate 61, and the power feeder 62 for supplying power to the antenna 65 are mounted to the circuit board 65. The bracket 67 is arranged around the antenna 65 (corresponding to the primary antenna 46) so as to define a third propagation path S3A around the antenna 65 and the bracket 67.

In the first embodiment, radio waves having the vertical polarization are mainly exchanged between the primary antenna 46 and the secondary antennas 36 through the first and second propagation paths S1 and S2.

The third propagation path S3A, which serves as the predetermined additional propagation path, according to this modification causes polarization rotation in radio waves transmitted from the primary antenna 46 and any secondary antenna 36.

For example, in the arrangement of FIGS. 1 to 3 according to the first embodiment, the monitoring device 40 transmits, from the antenna 65 (primary antenna 46), radio waves having the horizontal-polarization plane, and those radio waves are polarization-rotated by the third propagation path S3A into radio waves having the vertical-polarization plane. Thereafter, the radio waves having the vertical-polarization plane are received by at least one acquisition device 30.

Additionally, in the arrangement of FIGS. 1 to 3 according to the first embodiment, each acquisition device 30 transmit radio waves having the vertical-polarization plane, which are polarization-rotated by the third propagation path S3A into radio waves having the horizontal-polarization plane. Thereafter, the radio waves having the horizontal-polarization plane are received by the monitoring device 40.

Similarly, in the arrangement of FIGS. 7 to 9 according to the second embodiment, the monitoring device 40 transmits radio waves having the vertical-polarization plane, which are polarization-rotated by the third propagation path S3A into radio waves having the horizontal-polarization plane. Thereafter, the radio waves having the horizontal-polarization plane are received by at least one acquisition device 30. Additionally, in the arrangement of FIGS. 7 to 9 according to the second embodiment, each acquisition device 30 transmits radio waves having the horizontal-polarization plane, which are polarization-rotated by the third propagation path S3A into radio waves having the vertical-polarization plane. Thereafter, the radio waves having the vertical-polarization plane are received by the monitoring device 40.

Even in the modification of each of the first and second embodiments, the cutoff frequency defined based on the length of the cross section of the first propagation path S1 in the longitudinal direction in which the primary antenna 46 is disposed is lower than the communication frequency f0. Additionally, the cutoff frequency defined based on the length of the cross section of the second propagation path S2 in the longitudinal direction in which the secondary antennas 36 are disposed is lower than the communication frequency f0. Accordingly, the above modification of each of the first and second embodiments provides advantages that are similar to those of the corresponding one of the first and second embodiments.

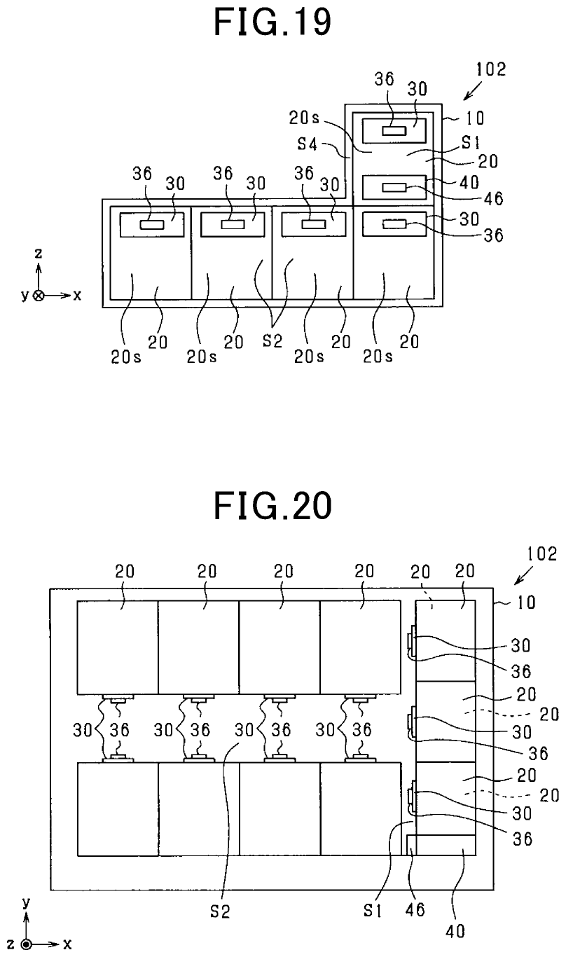

As illustrated in a side view of FIG. 19, the battery packs 20, each of which has a rectangular-parallelepiped shape, of a battery system 102 may be arranged side by side in the respective left-right direction X and the top-bottom direction Z. In FIG. 19, the corresponding side wall portion of the housing 10 is omitted. The monitoring device 40 may be mounted on an outer side surface 20s of any battery pack 20, and each acquisition device 30 may be mounted on an outer side surface 20s of the corresponding battery pack 20.

In the battery system 102, a fourth propagation path S4 is formed between the first propagation path S1 and the second propagation path S2; the length of the cross section of the fourth propagation path S4 in a certain direction is so short that it impacts how radio waves propagate through the fourth propagation path S4. In this modification, it is necessary for the primary antenna 46 to use the polarization plane of radio waves, which is configured such that the cutoff frequency defined based on the length of the cross section of the fourth propagation path S4 in the longitudinal direction is lower than the communication frequency f0. Similarly, it is necessary for each secondary antenna 36 to use the polarization plane of radio waves, which is configured such that the cutoff frequency defined based on the length of the cross section of the fourth propagation path S4 in the longitudinal direction is lower than the communication frequency f0.

As illustrated in a plan view of FIG. 20, the battery packs 20, each of which has a rectangular-parallelepiped shape, of a battery system 102 may be arranged side by side in the respective left-right direction X and the up-down direction Z. In FIG. 20, the upper wall portion of the housing 10 is omitted. In the right part of the housing 10, the battery packs 20 are stacked in two stages vertically. The monitoring device 40 is mounted on the front outer side surface of the battery pack 20 disposed at the right front. In a one-stage region of battery packs 20, the acquisition devices 30 are mounted on laterally central outer side surfaces of the respective battery packs 20 in the front-rear direction Y. In a two-stage region of battery packs 20, the acquisition devices 30 are mounted on left outer side surfaces of the respective battery packs 20.

Even in this modification, the monitoring device 40 mainly includes the primary antenna 46 for transmitting and receiving radio waves having a polarization plane in the predetermined direction more strongly than radio waves having polarization planes in other directions, and each acquisition device 30 mainly includes the secondary antenna 36 for transmitting and receiving radio waves having a polarization plane in the predetermined direction more strongly than radio waves having polarization planes in other directions.

In this modification, the polarization plane in the predetermined direction is configured such that the following cutoff frequencies are both lower than the communication frequency f0:
(i) the cutoff frequency f1 defined based on the length of the cross section of the first propagation path S1 in the longitudinal direction in which the primary antenna 46 is provided; and
(ii) the cutoff frequency f2 defined based on the length of the cross section of the second propagation path S2 in the longitudinal direction in which the second antennas 36 are provided.

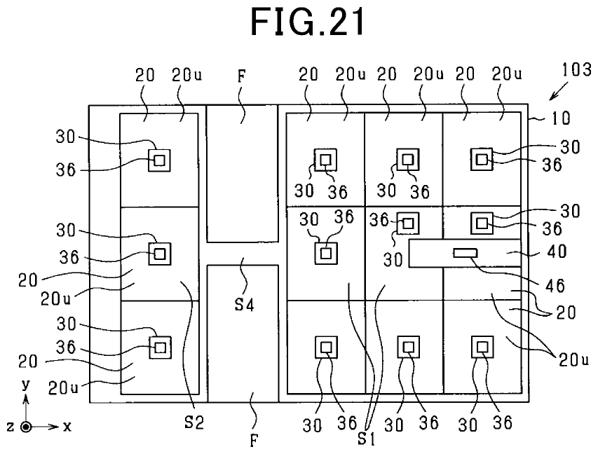

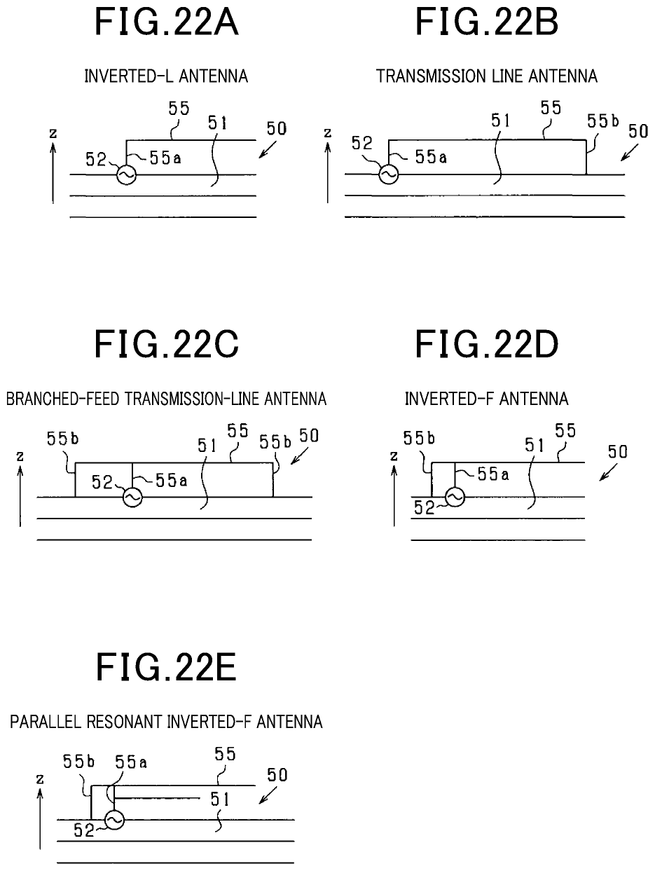

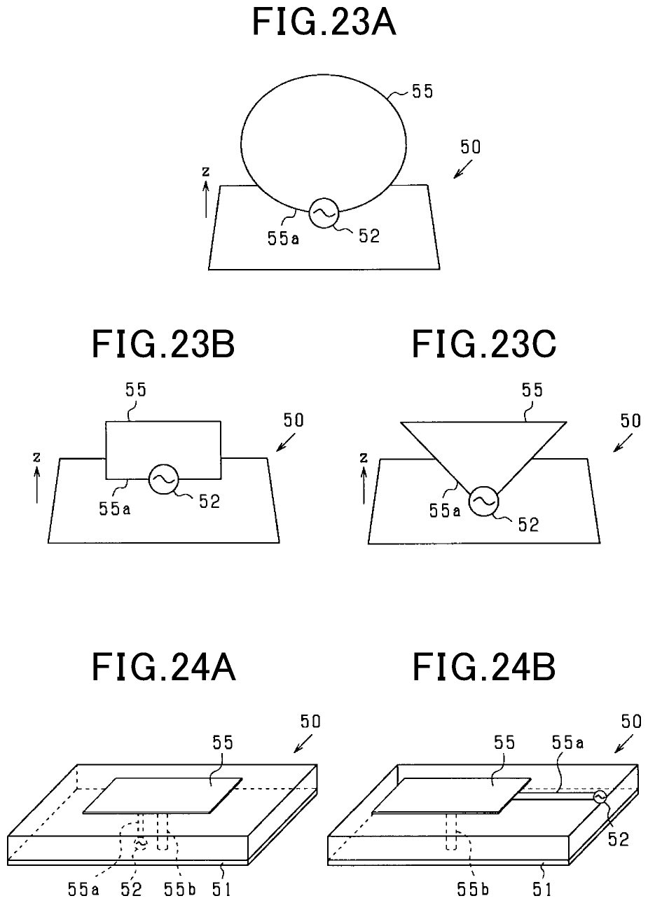

As illustrated in a plan view of FIG. 21, the battery packs 20, each of which has a rectangular-parallelepiped shape, of a battery system 103 may be arranged side by side in the left-right direction X and the front-rear direction Y. In the battery system 103 illustrated in FIG. 21, the upper wall portion of the housing 10 is omitted.

A foot space F is a space outside the housing 10 in which a vehicle driver places his or her feet. The monitoring device 40 is mounted on the upper surfaces 20u of selected adjacent battery packs 20, and the acquisition devices 30 are mounted on the outer upper surfaces 20u of the respective battery packs 20. In wireless communication between the monitoring device 40 and each acquisition device 30, radio waves may pass through a fourth propagation path S4 between the first propagation path S1 and the second propagation path S2. The length of the cross section of the fourth propagation path S4 in a certain direction is so short that it impacts how radio waves propagate through the fourth propagation path S4. In this modification, it is necessary for the primary antenna 46 to use the polarization plane of radio waves, which is configured such that the cutoff frequency defined based on the length of the cross section of the fourth propagation path S4 in the longitudinal direction is lower than the communication frequency f0. Similarly, it is necessary for each secondary antenna 36 to use the polarization plane of radio waves, which is configured such that the cutoff frequency defined based on the length of the cross section of the fourth propagation path S4 in the longitudinal direction is lower than the communication frequency f0.

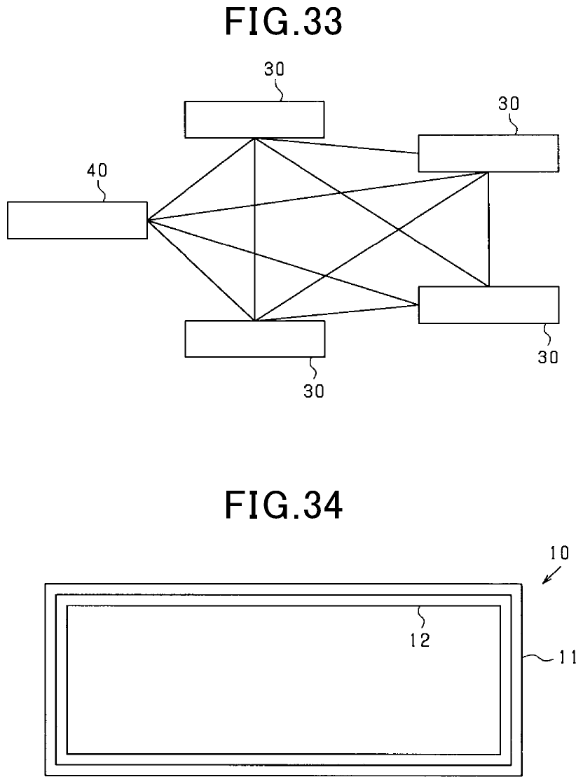

As illustrated in FIG. 33, the monitoring device 40 and the acquisition devices 30 may be configured to perform mesh communication. Wireless communication devices disposed in propagation paths formed between the housing 10 and the battery packs 20 may be wireless communication devices used for purposes other than the monitoring device 40 and the acquisition devices 30. In that case, it is unnecessary for the wireless communication devices to be distinguished as primary and secondary devices.

The housing 10 may be formed of a conductive material other than metal, such as conductive plastic. Alternatively, as illustrated in FIG. 35, the housing 10 may have an outer layer 11 formed of a non-conductive material such as resin and an inner layer 12 formed of a conductive material such as metal plating.

The above embodiments and modifications may be combined with one another to the extent they are compatible.

Various technical matters are disclosed in the above embodiments and modifications. Accordingly, for example, in each of the wireless communication systems 101, 102, and 103 including the housing 10, the battery packs 20 disposed in the housing 10, and at least one of the wireless communication devices 40, 30 having at least one of the antennas 46, 36, 55, 65 for transmitting and receiving radio waves as wireless communication with one another at the predetermined communication frequency, some of the technical matters disclosed in the above embodiments and modifications may be appropriately added and applied.

Depending on the technical matters to be applied, antennas other than those described in the embodiments and modifications, such as omni-directional antennas, may also be used. Any technical matters may also be appropriately combined with one another, and some technical matters may be appropriately omitted.

Although the present disclosure has been described with reference to the embodiments and modifications, it should be understood that the present disclosure is not limited to the embodiments and modifications and their structures. The present disclosure encompasses various modifications and equivalent arrangements. In addition, various combinations and forms, and other combinations and forms including only one element thereof, more elements, or fewer elements, also fall within the scope of the present disclosure.

1. A wireless communication system comprising:
a housing formed of a conductive material;
a plurality of battery packs installed in the housing, each of the battery packs having outer surfaces formed of a conductive material; and
a plurality of wireless communication devices, each of which mainly includes an antenna, the antenna of each of the wireless communication devices being disposed in a corresponding one of propagation paths defined between the housing and one or more of the battery packs, the wireless communication devices being configured to perform radio-wave wireless communication with one another using a predetermined communication frequency,
the antenna of each of the wireless communication devices being configured to transmit and receive radio waves having a predetermined-directional polarization plane more strongly than other radio waves having polarization planes other than the predetermined-directional polarization plane,
the predetermined-directional polarization plane of the antenna of each of the wireless communication devices being configured such that a cutoff frequency defined based on a longitudinal length of a cross section of the corresponding one of the propagation paths is lower than the predetermined communication frequency.

2. The wireless communication system according to claim 1, wherein:
the plurality of wireless communication devices includes a first wireless communication device and a second wireless communication device that are configured to perform radio-wave wireless communication with one another using the predetermined communication frequency;
the propagation paths include a first propagation path in which the antenna of the first wireless communication device is disposed, a first polarization plane and a second polarization plane orthogonal to each other being defined in the first propagation path;
a first radio-wave cutoff frequency of the first polarization plane is defined in the first propagation path;
a third radio-wave cutoff frequency of the second polarization plane is defined in the first propagation path;
the propagation paths include a second propagation path in which the antenna of the second wireless communication device is disposed;
a second radio-wave cutoff frequency of the first polarization plane is defined in the second propagation path;
a fourth radio-wave cutoff frequency of the second polarization plane is defined in the second propagation path;
the predetermined communication frequency is set to be higher than the first and third radio-wave cutoff frequencies, higher than the second radio-wave cutoff frequency, and lower the fourth radio-wave cutoff frequency; and
the predetermined-directional plane is the first polarization plane.

3. The wireless communication system according to claim 2, wherein:
the housing has an inner upper surface, an inner lower surface, and a pair of inner side surfaces;
the first propagation path is defined by the inner upper surface, the inner lower surface, and the pair of inner side surfaces of the housing;
a distance between the inner upper and lower surfaces of the housing is smaller than that between the pair of inner side surfaces of the housing;
the outer surfaces of each battery pack include an outer upper surface;
the second propagation path is defined by the inner upper surface of the housing, the outer upper surfaces of the battery packs, and the pair of inner side surfaces of the housing;
a distance between the inner upper surface of the housing and the outer upper surface of each battery pack is smaller than that between the pair of inner side surfaces of the housing;
the first polarization plane is a vertical-polarization plane; and
the second polarization plane is a horizontal-polarization plane.

4. The wireless communication system according to claim 1, wherein:
the plurality of wireless communication devices includes a first wireless communication device and a second wireless communication device that are configured to perform radio-wave wireless communication with one another using the predetermined communication frequency;
the propagation paths include a first propagation path in which the antenna of the first wireless communication device is disposed, a first polarization plane and a second polarization plane orthogonal to each other being defined in the first propagation path;
a first radio-wave cutoff frequency of the first polarization plane is defined in the first propagation path;
a third radio-wave cutoff frequency of the second polarization plane is defined in the first propagation path;
the propagation paths include a second propagation path in which the antenna of the second wireless communication device is disposed;
a second radio-wave cutoff frequency of the first polarization plane is defined in the second propagation path;
a fourth radio-wave cutoff frequency of the second polarization plane is defined in the second propagation path;
the predetermined communication frequency is set to be higher than the first and third radio-wave cutoff frequencies, lower than the second radio-wave cutoff frequency, and higher than the fourth radio-wave cutoff frequency; and
the predetermined-directional plane is the second polarization plane.

5. The wireless communication system according to claim 4, wherein:
the housing has an inner upper surface, an inner lower surface, and a pair of inner side surfaces;
the first propagation path is defined by the inner upper surface, the inner lower surface, and the pair of inner side surfaces of the housing;
a distance between the inner upper and lower surfaces of the housing is smaller than that between the pair of inner side surfaces of the housing;
the outer surfaces of each battery pack include an outer side surface;
the second propagation path is defined by the inner upper surface of the housing, the inner lower surface of the housing, the outer side surfaces of the battery packs, and one of the pair of inner side surfaces of the housing;
a distance between the inner upper and lower surfaces of the housing is greater than that between the outer side surface of each battery pack and the one of the pair of inner side surfaces of the housing;
the first polarization plane is a vertical-polarization plane; and
the second polarization plane is a horizontal-polarization plane.

6. The wireless communication system according to claim 1, wherein:
the plurality of wireless communication devices includes a first wireless communication device and a second wireless communication device that are configured to perform radio-wave wireless communication with one another using the predetermined communication frequency;
the propagation paths include a first propagation path in which the antenna of the first wireless communication device is disposed, a first polarization plane and a second polarization plane orthogonal to each other being defined in the first propagation path;
a first radio-wave cutoff frequency of the first polarization plane is defined in the first propagation path;
a third radio-wave cutoff frequency of the second polarization plane is defined in the first propagation path;
the propagation paths include a second propagation path in which the antenna of the second wireless communication device is disposed;
a second radio-wave cutoff frequency of the first polarization plane is defined in the second propagation path;
a fourth radio-wave cutoff frequency of the second polarization plane is defined in the second propagation path;
a predetermined additional propagation path is present between the antenna of the first wireless communication device and the antenna of the second wireless communication device, the predetermined additional propagation path resulting in polarization rotation in radio waves transmitted from the antenna of each of the first and second wireless communication devices;
the predetermined communication frequency is set to be higher than the first and third radio-wave cutoff frequencies, lower than the second radio-wave cutoff frequency, and higher than the fourth radio-wave cutoff frequency; and
the predetermined-directional plane is the second polarization plane at a position of the antenna of the second wireless communication device in the second propagation path.

7. The wireless communication system according to claim 6, wherein:
the housing has an inner upper surface, an inner lower surface, and a pair of inner side surfaces;
the first propagation path is defined by the inner upper surface, the inner lower surface, and the pair of inner side surfaces of the housing;
a distance between the inner upper and lower surfaces of the housing is smaller than that between the pair of inner side surfaces of the housing;
the outer surfaces of each battery pack include an outer upper surface;
the predetermined additional propagation path includes a third propagation path that is defined by the inner upper surface of the housing, the outer upper surfaces of the battery packs, and the pair of inner side surfaces of the housing;
a distance between the inner upper surface of the housing and the outer upper surface of each battery pack is smaller than that between the pair of inner side surfaces of the housing;
the second propagation path is defined by the inner upper surface of the housing, the inner lower surface of the housing, the outer side surfaces of the battery packs, and one of the pair of inner side surfaces of the housing;
a distance between the inner upper and lower surfaces of the housing is greater than that between the outer side surface of each battery pack and the one of the pair of inner side surfaces of the housing; and
the second polarization plane is a horizontal polarization plane at the position of the antenna of the second wireless communication device in the second propagation path.

8. The wireless communication system according to claim 1, wherein:
each of the wireless communication devices includes only the antenna configured to transmit and receive the radio waves having the predetermined-directional polarization plane more strongly than the other radio waves having the polarization planes other than the predetermined-directional polarization plane.

9. A wireless communication system comprising:
a housing formed of a conductive material and having an inner upper surface, an inner lower surface, and a pair of inner side surfaces;
a plurality of battery packs installed in the housing, each of the battery packs having outer surfaces formed of a conductive material, the outer surfaces including an outer upper surface;
a first wireless communication device; and
a second wireless communication device, wherein:
each of the first and second communication devices mainly includes an antenna disposed in a corresponding one of first and second propagation paths defined between the housing and one or more of the battery packs, the first and second wireless communication devices being configured to perform radio-wave wireless communication with one another using a predetermined communication frequency;
a first radio-wave cutoff frequency of a vertical polarization plane is defined in the first propagation path;
a third radio-wave cutoff frequency of a horizontal polarization plane is defined in the first propagation path;
the first propagation path is defined by the inner upper surface, the inner lower surface, and the pair of inner side surfaces of the housing;
a distance between the inner upper and lower surfaces of the housing is smaller than that between the pair of inner side surfaces of the housing;
a second radio-wave cutoff frequency of the vertical polarization plane is defined in the second propagation path;
a fourth radio-wave cutoff frequency of the horizontal polarization plane is defined in the second propagation path;
the second propagation path is defined by the inner upper surface of the housing, the outer upper surfaces of the battery packs, and the pair of inner side surfaces of the housing;
a distance between the inner upper surface of the housing and the outer upper surface of each battery pack is smaller than that between the pair of inner side surfaces of the housing;
the predetermined communication frequency is set to be higher than the first and third radio-wave cutoff frequencies, higher than the second radio-wave cutoff frequency, and lower than the fourth radio-wave cutoff frequency; and
the antenna of each of the first and second wireless communication devices is configured to transmit and receive radio waves having the vertical polarization plane more strongly than other radio waves having directional polarization planes other than the vertical polarization plane.

10. The wireless communication system according to claim 9, wherein:
each of the first and second wireless communication devices includes only the antenna configured to transmit and receive the radio waves having the vertical polarization plane more strongly than the other radio waves having the polarization planes other than the vertical polarization plane.

11. A wireless communication system comprising:
a housing formed of a conductive material and having an inner upper surface, an inner lower surface, and a pair of inner side surfaces;
a plurality of battery packs installed in the housing, each of the battery packs having outer surfaces formed of a conductive material, the outer surfaces including an outer side surface;
a first wireless communication device; and
a second wireless communication device, wherein:
each of the first and second communication devices mainly includes an antenna disposed in a corresponding one of first and second propagation paths defined between the housing and one or more of the battery packs, the first and second wireless communication devices being configured to perform radio-wave wireless communication with one another using a predetermined communication frequency;
a first radio-wave cutoff frequency of a vertical polarization plane is defined in the first propagation path;
a third radio-wave cutoff frequency of a horizontal polarization plane is defined in the first propagation path;
the first propagation path is defined by the inner upper surface, the inner lower surface, and the pair of inner side surfaces of the housing;
a distance between the inner upper and lower surfaces of the housing is smaller than that between the pair of inner side surfaces of the housing;
a second radio-wave cutoff frequency of the vertical polarization plane is defined in the second propagation path;
a fourth radio-wave cutoff frequency of the horizontal polarization plane is defined in the second propagation path;
the second propagation path is defined by the inner upper surface of the housing, the inner lower surface of the housing, the outer side surfaces of the battery packs, and one of the pair of inner side surfaces of the housing;
a distance between the inner upper and lower surfaces of the housing is greater than that between the outer side surface of each battery pack and the one of the pair of inner side surfaces of the housing;
the predetermined communication frequency is set to be higher than the first and third radio-wave cutoff frequencies, lower than the second radio-wave cutoff frequency, and higher than the fourth radio-wave cutoff frequency; and
the antenna of each of the first and second wireless communication devices is configured to transmit and receive radio waves having the horizontal polarization plane more strongly than other radio waves having directional polarization planes other than the horizontal polarization plane.

12. The wireless communication system according to claim 11, wherein:
each of the first and second wireless communication devices includes only the antenna configured to transmit and receive the radio waves having the horizontal polarization plane more strongly than the other radio waves having the polarization planes other than the horizontal polarization plane.

13. The wireless communication system according to claim 3, wherein:
the antenna of each of the first and second wireless communication devices, which is configured to transmit and receive the radio waves having the vertical polarization plane, is mounted to a circuit board for wireless communication;
the antenna includes at least one of a first predetermined antenna portion connected to a power feeder that supplies power to the antenna, and a second predetermined portion connected to a ground plate;
the at least one of the first predetermined antenna portion and the second predetermined antenna portion is provided in an upright state relative to the circuit board; and
the ground plate is located below the at least one of the first predetermined antenna portion and the second predetermined antenna portion.

14. The wireless communication system according to claim 3, wherein:
the antenna of each of the first and second wireless communication devices, which is configured to transmit and receive the radio waves having the horizontal polarization plane, is mounted to a circuit board for wireless communication;
the antenna includes at least one of a first predetermined antenna portion connected to a power feeder that supplies power to the antenna, and a second predetermined portion connected to a ground plate;
the at least one of the first predetermined antenna portion and the second predetermined antenna portion is provided in an upright state relative to the circuit board; and
the ground plate is arranged without being located below the first and second predetermined antenna portions.

15. The wireless communication system according to claim 1, wherein:
the housing of the wireless communication system formed of the conductive material is installed in a hybrid vehicle or an electric vehicle.
